(19) United States
(12) Patent Application Publication
(10) Pub. No.: US 2008/0159709 A1
(43) Pub. Date: Jul. 3, 2008

(54) RECORDING APPARATUS, RECORDING/REPRODUCING SYSTEM, RECORDING METHOD

(75) Inventor: Masataka MOTEKI, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/867,237

(22) Filed: Oct. 4, 2007

(30) Foreign Application Priority Data
Dec. 27, 2006 (JP) 2006-352111

(51) Int. Cl. H04N 5/91

(52) U.S. Cl. 386/95; 386/E05.001

(57) ABSTRACT

The recording apparatus includes: first and second area generating units generating, in a recording medium, first and second recording areas, respectively, for recording first stream data and for repeatedly overwrite-recording second stream data different from the first stream data and taken as an object of reproduction for a predetermined period; a recording unit recording the second stream data into the second recording area; a time information obtaining unit obtaining a time length of the second stream data; a loop time managing unit updating a length of the predetermined period to a length equal to or longer than the time length, when comparison therebetween, in response to a save instruction of the second stream data, shows the time length is longer than the predetermined period; and an area transfer unit transferring, to the first recording area, the second stream data having the time length and recorded in the second recording area.

### CROSS-REFERENCE TO RELATED APPLICATIONS

This application is based upon and claims the benefit of priority from the prior Japanese Patent Application No. 2006-352111, filed on Dec. 27, 2006; the entire contents of which are incorporated herein by reference.

### BACKGROUND OF THE INVENTION

1. Field of the Invention

The present invention relates to a recording apparatus, such as, for example, a hard disk video recorder, which records data, and to a recording method.

2. Description of the Related Art

A video recorder recording television programs and so on can execute so-called timer recording based on registered start time and end time of a program to be recorded. However, if the broadcast time of a live sport program or the like is unexpectedly changed, the recording is ended before the program ends. To solve this problem, a technique to correct the end time has been proposed (for example, JP-A 2006-203912 (KOKAI)).

In a field of a video recorder and the like utilizing a large-capacity storage medium such as a hard disk, a recording method called loop recording is under development. The loop recording is a recording mode to reserve a fixed area separately from a normal recording area and repeat overwrite-recording into the fixed area independently of normal recording. Though limited in recording capacity, the loop recording enables recording without a user paying attention to a remaining capacity of the storage medium. Therefore, for example, with the use of the loop recording, the user can have a currently watched program temporarily stored when leaving in the middle of the program and later resume watching the program from a scene where the user stopped watching when he/she left.

In the loop recording, upon start of the loop recording in response to a user's operation, recording into the loop recording area begins, and when the recording progresses up to an end point of the area, subsequent recording continues from a start point of the area. Therefore, even if a user desires long-term saving of contents recorded during the loop recording, a portion not falling within the repetition time of the loop recording (loop time) is overwritten.

### BRIEF SUMMARY OF THE INVENTION

As described above, recording apparatuses, recording/reproducing systems, and recording methods in conventional arts have a problem that, when video contents currently loop-recorded are saved, a portion thereof not falling within the loop time cannot be saved.

It is an object of the present invention to provide a recording apparatus, a recording/reproducing system, and a recording method capable of saving desired video contents in their entirety irrespective of the loop recording time.

A recording apparatus according to an aspect of the present invention is a recording apparatus which records stream data into a storage medium, the apparatus including: a first area generating unit generating, in the recording medium, a first recording area used for recording first stream data; a second area generating unit generating, in the recording medium, a second recording area used for repeatedly overwrite-recording second stream data, the second stream data being different from the first stream data and taken as an object of reproduction only for a predetermined period; a recording unit recording the second stream data into the second recording area; a time information obtaining unit obtaining a time length taken to record the second stream data; a loop time managing unit which compares the time length and the predetermined period in response to a save instruction of the second stream data, and when the time length is longer than the predetermined period, updates a length of the predetermined period to a length equal to or longer than the time length; and an area transfer unit transferring, to the first recording area, the second stream data having the time length and recorded in the second recording area.

A recording/reproducing system according to another aspect of the present invention is a recording/reproducing system which records/reproduces stream data into/from a storage medium, the system including: a first area generating unit generating, in the recording medium, a first recording area used for recording first stream data; a second area generating unit generating, in the recording medium, a second recording area used for repeatedly overwrite-recording second stream data, the second stream data being different from the first stream data and taken as an object of reproduction only for a predetermined period; a recording unit recording the second stream data into the second recording area; a time information obtaining unit obtaining a time length taken to record the second stream data; a loop time managing unit which compares the time length and the predetermined period in response to a save instruction of the second stream data, and when the time length is longer than the predetermined period, updates a length of the predetermined period to a length equal to or longer than the time length; an area transfer unit transferring, to the first recording area, the second stream data having the time length and recorded in the second recording area; and a display unit displaying at least one of the second stream data recorded in the second recording area and the second stream data transferred to the first recording area.

A recording method according to still another aspect of the present invention is a recording method of recording stream data into a storage medium, the method including: generating, in the recording medium, a first recording area used for recording first stream data; generating, in the recording medium, a second recording area used for repeatedly overwrite-recording second stream data, the second stream data being different from the first stream data and taken as an object of reproduction only for a predetermined period; recording the second stream data into the second recording area; obtaining a time length taken to record the second stream data; comparing the time length and the predetermined period in response to a save instruction of the second stream data, and when the time length is longer than the predetermined period, updating a length of the predetermined period to a length equal to or longer than the time length; and transferring, to the first recording area, the second stream data having the time length and recorded in the second recording area.

### BRIEF DESCRIPTION OF THE DRAWINGS

FIG. 1 is a block diagram showing the configuration of a recording apparatus of a first embodiment according to the present invention.

FIG. 2 is a schematic chart showing an overview of data configuration in the recording apparatus of the first embodiment.

FIG. 3 is a block diagram showing the configuration of a recording management information control unit shown in FIG. 1.

FIG. 4 is a flowchart showing a loop recording operation of the recording apparatus according to the first embodiment.

FIG. 5 is a schematic chart showing a recording operation of normal recording in the first embodiment.

FIG. 6 is a schematic chart showing a recording operation of loop recording in the first embodiment.

FIG. 7 is a schematic chart showing a recording operation of loop recording in the first embodiment.

FIG. 8 is a schematic chart showing a recording operation of loop recording in the first embodiment.

FIG. 9 is a schematic chart showing a recording operation of loop recording in the first embodiment.

FIG. 10 is a schematic chart showing a recording operation of loop recording in the first embodiment.

FIG. 11 is a schematic chart showing a recording operation of loop recording in the first embodiment.

FIG. 12 is a schematic chart showing a recording operation of loop recording in the first embodiment.

FIG. 13 is a view showing a concrete example of a key input unit of a remote control type.

FIG. 14 is a view showing an example of a display screen of a display unit.

FIG. 15 is a view showing an example of a display screen of the display unit.

FIG. 16 is a view showing an example of a display screen of the display unit.

FIG. 17 is a view showing an example of a display screen of the display unit.

FIG. 18 is a view showing an example of a display screen of the display unit.

FIG. 19 is a view showing an example of a display screen of a display unit.

FIG. 20 is a flowchart showing a loop recording operation of a recording apparatus of a second embodiment according to the present invention.

FIG. 21 is a schematic chart showing a recording operation of loop recording in the second embodiment.

FIG. 22 is a schematic chart showing a recording operation of loop recording in the second embodiment.

FIG. 23 is a schematic chart showing a recording operation of loop recording in the second embodiment.

FIG. 24 is a schematic chart showing a recording operation of loop recording in the second embodiment.

FIG. 25 is a schematic chart showing a recording operation of loop recording in the second embodiment.

FIG. 26 is a schematic chart showing a recording operation of loop recording in the second embodiment.

FIG. 27 is a schematic chart showing a recording operation of loop recording in the second embodiment.

FIG. 28 is a schematic chart showing a recording operation of loop recording in the second embodiment.

FIG. 29 is a schematic chart showing recording areas in a modified example of the first embodiment.

FIG. 30 is a schematic chart showing recording areas in a modified example of the second embodiment.

### DETAILED DESCRIPTION OF THE INVENTION

In a video recorder (recording apparatus), a television set, and the like having a so-called loop recording function, when a user temporarily stops watching a television program, for example, because he/she leaves, the user can perform a loop recording activation operation and when resuming watching the television program later, the user can reproduce the program from a position where he/she stooped watching, by performing an activation operation of a “chasing playback”.

There are many conceivable forms about when to start and end the loop recording, that is, how long the loop recording is to be continued, since it depends on how the loop recording function is used. For example, in a case where the loop recording function is used in a manner that a currently watched program is temporarily stored when a user leaves in the middle of the program and the user later resumes watching the program from a position where he/she stopped watching because he/she left, the loop recording is executed within a relatively limited time, that is, within the time during which the user is absent. On the other hand, in a case where the loop function is used in a manner that loop recording is executed without any consciousness by a user, such as a case, for example, where a recording apparatus is built in a television set and the loop recording function is automatically activated upon power-on of the television set, the loop recording is executed for a relatively long time, that is, for a period during which the television set is on.

In the latter case, the loop recording is executed for a relatively long time, and if a user wants to save what is being loop-recorded, recorded contents have to be transferred to a long-term recording area as an archive.

In embodiments of the present invention described below, the loop recording time is changeable depending on video contents, thereby realizing the saving of desired video contents in their entirety.

### FIRST EMBODIMENT

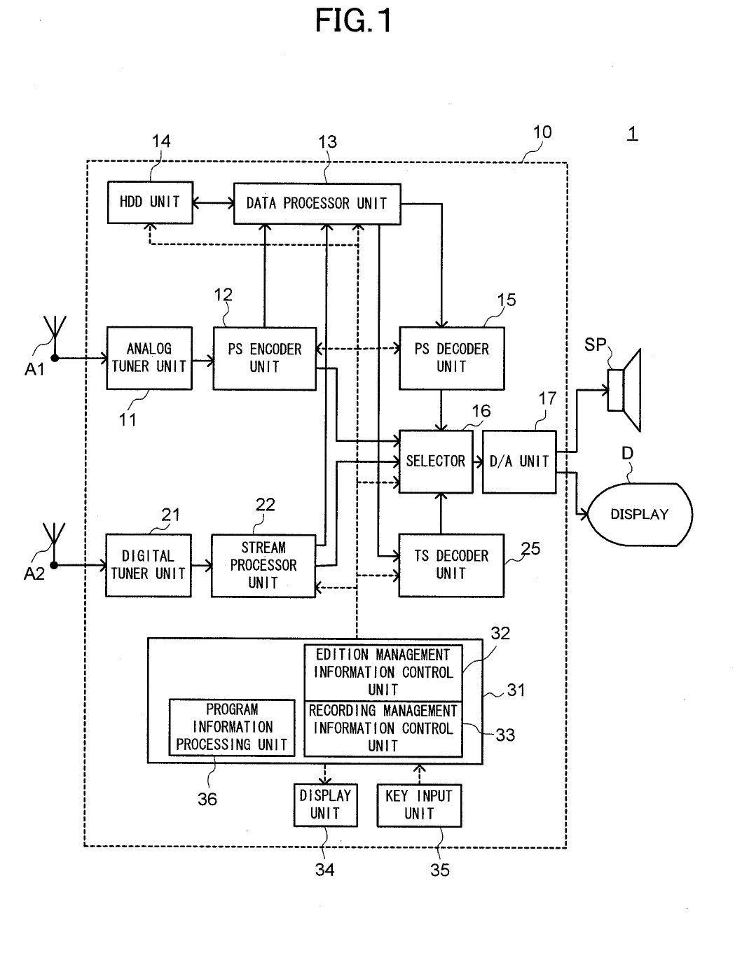

Hereinafter, the embodiments of the present invention will be described in detail with reference to the drawings. FIG. 1 is a block diagram showing the configuration of a recording apparatus of a first embodiment according to the present invention.

As shown in FIG. 1, a recording apparatus 10 of this embodiment constitutes a television system 1 together with a speaker SP, a display D, an analog antenna A1 receiving terrestrial analog broadcasts, and a digital antenna A2 receiving terrestrial, BS, and CS digital broadcasts.

The recording apparatus 10 of this embodiment includes an analog tuner unit 11, a PS encoder unit 12, a data processor unit 13, a HDD unit 14, a PS decoder unit 15, a selector 16, a D/A unit 17, a digital tuner unit 21, a stream processor unit 22, a TS decoder unit 25, an arithmetic operation unit (CPU unit) 31, a display unit 34, and a key input unit 35, and the CPU unit 31 has an edition management information control unit 32, a recording management information control unit 33, and a program information processing unit 36.

The analog tuner unit 11 is an analog tuner receiving, via the analog antenna A1, waves of analog broadcasts which are broadcast mainly by means of terrestrial waves. The analog tuner unit 11 tunes to a specific broadcast wave and demodulates it based on a predetermined broadcast standard such as NTSC to convert the broadcast wave into an analog video signal and an analog audio signal and inputs the converted video and audio signals to the PS encoder unit 12. The analog tuner unit 11 also has a function of obtaining program information (information used for screen display of EPG: Electronic Program Guide) superimposed on the analog broadcast wave.

The PS encoder unit 12 is an encoder including an A/D converter converting the inputted analog video and audio signals into digital signals, a video encoder, and an audio encoder. The PS encoder unit 12 may further include a sub-video encoder. The PS encoder unit 12 converts the digitized video signal into a compressed digital video signal with a variable bit rate complying with the MPEG2 or MPEG1 standard. The PS encoder unit 12 also converts the digitized audio signal into a compressed digital audio signal with a fixed bit rate complying with the MPEG or AC-3 standard or into a digital audio signal of linear PCM. Upon receipt of the analog video signal and the analog audio signal from the analog tuner unit 11, the PS encoder unit 12 performs predetermined encoding processing. Specifically, after converting the video signal and the audio signal into digital signals, the PS encoder unit 12 encodes the digital video and audio signals and thereafter packs these signals, thereby converting the encoded signals into a video pack, an audio pack, and a sub-video pack. Then, the PS encoder unit 12 combines these packs and converts a format suitable for recording into the HDD unit 14. The signals converted by the PS encoder unit 12 are sent to the data processor unit 13. Incidentally, the PS encoder unit 12 may send the digital video and audio signals resulting from the A/D conversion directly to the selector 16 without encoding them.

The data processor unit 13 is a data controller receiving the digital video and audio signals encoded by the PS encoder unit 12 and writing the received digital video and audio signals into the HDD unit 14 on a subsequent stage. Specifically, the data processor unit 13 receives data on a per GOP basis from a formatter included in the PS encoder unit 12 in a case of recording of contents of an analog broadcast, and from the stream processor unit 22 in a case of recording of contents of a digital broadcast, and records the received data into the HDD unit 14. The data processor unit 13 also has a function of reading predetermined reproduced signals from the HDD unit 14. The data processor unit 13 includes a buffer circuit, a modulator/demodulator circuit, an error corrector circuit, and so on, and data processing for recording and for reproduction by the data processor unit 13 are executed independently of each other.

The HDD unit 14 is a recorder recording/reproducing data by driving a storage medium such as, for example, a hard disk.

The PS decoder unit 15 is a decoder including: a separator separating and extracting packs such as video packs and audio packs from multiplexed signals recorded in a packed structure in the HDD unit 14; a memory used when signal processing such as the pack separation and other processing are executed; a video decoder decoding main video data (contents of the video packs) separated by the separator, a sub-picture decoder decoding sub-video data (contents of sub-video packs) separated by the separator; and an audio decoder decoding audio data (contents of the audio packs) separated by the separator. The PS decoder unit 15 may include a video processor which appropriately combines the decoded sub video with the decoded main video, and outputs the main video with a menu, a highlight button, a sub title, and other sub video superimposed thereon. The PS decoder unit 15 basically decodes A/D converted video and audio signals of an analog broadcast wave which are recorded in the HDD unit 15.

The selector 16 is a signal switcher for selecting signals from output signals from the PS decoder unit 15, output signals from the TS decoder unit 25, output signals from the PS encoder unit 12, and output signals from the stream processor unit 22, and outputting the selected output signals to the D/A unit 17. That is, the selector 16 selects signals from signals of an analog broadcast wave recorded in the HDD unit 14, signals of a digital broadcast wave recorded in the HDD unit 14, signals of an analog broadcast wave digitized by the PS encoder unit 12, and signals of a digital broadcast wave from the stream processor unit 22. The selection by the selector 16 is based on a select signal from the CPU unit 31.

The D/A unit 17 is a D/A converter converting a digital video signal and a digital audio signal selected by the selector 16 into an analog video signal and an analog audio signal respectively. The D/A unit 17 outputs the analog video signal and the analog audio signal resulting from the D/A conversion to the display D and the speaker SP respectively.

The digital tuner unit 21 corresponds to the analog tuner unit 11 and is a digital tuner receiving digital broadcast waves of terrestrial broadcasting, BS broadcasting, CS broadcasting, and the like via the digital antenna A2. The digital tuner unit 21 extracts TS packets, such as video packets and audio packets of a program selected by a user, from MPEG2-TS signals to input the extracted TS packets to the stream processor unit 22. The digital tuner unit 21 has a function of extracting program information used for the aforesaid EPG, which is packetized with the digital broadcast wave.

The stream processor unit 22 is a data converter processing the video data, the audio data, data of the program information, and so on which are extracted by the digital tuner unit 21. For example, the stream processor unit 22 converts these data, which are small divided TS packets, into large-sized packets suitable for recording into the HDD unit 14. Data resulting from the conversion are recorded into the HDD unit 14 via the data processor unit 13.

The TS decoder unit 25 corresponds to the PS decoder unit 15 and is a decoder decoding recorded signals of a digital broadcast wave which are read from the HDD unit 14 via the data processor unit 13. The TS decoder unit 25 includes: a separator separating and extracting video data, audio data, and so on from the recorded multiplexed signals; a video decoder decoding the separated video data; and an audio decoder decoding the separated audio data. The TS decoder unit 25 inputs the decoded digital video and audio signals to the selector 16.

According to a control program, the CPU unit 31 executes processing such as defective location detection, unrecorded area detection, setting of recording information recording position, UDF recording, and AV address setting. The CPU unit 31 has an information processor necessary for controlling the entire system, and includes a work RAM, a video management information generator, a copy-related information detector, a copy and scrambling information processor, a packet header processor, a sequence header processor, an aspect ratio information processor, and so on, which are not shown.

The CPU unit 31 further includes: the edition management information control unit 32 controlling management information which is used when edition is executed; a recording management information control unit 33 controlling management information which is used when recording is executed; and a program information processing unit 36 managing program information sent by means of an analog broadcast wave and a digital broadcast wave. Further, the CPU unit 31 generates management information necessary for reproducing recorded data and sends the generated management information to the data processor unit 13 at the end of data recording. Consequently, the management information is recorded into the HDD unit 14. Therefore, the CPU unit 31 receives information on a per data basis (separated information and so on) from the PS encoder unit 12 while encoding is underway, and from the stream processor unit 22 while recording of an MPEG2-TS signal is underway. The CPU unit 31 has a function of checking, at the beginning of the recording, file system management information read from the hard disk, thereby checking an unrecorded area in the hard disk, and setting a data recording area in the hard disk via the data processor unit 13.

The edition management information control unit 32 is a management data controller editing management information corresponding to video signals and audio signals recorded in the HDD unit 14.

The recording management information control unit 33 is a management data controller controlling the recording of video signals and audio signals into the HDD unit 14 and performing the setting of management information and the like.

The program information processing unit 36 is a data processor receiving the program information extracted by the analog tuner unit 11 and/or obtained by the digital tuner unit 21 to obtain the start/end times and the like of a program.

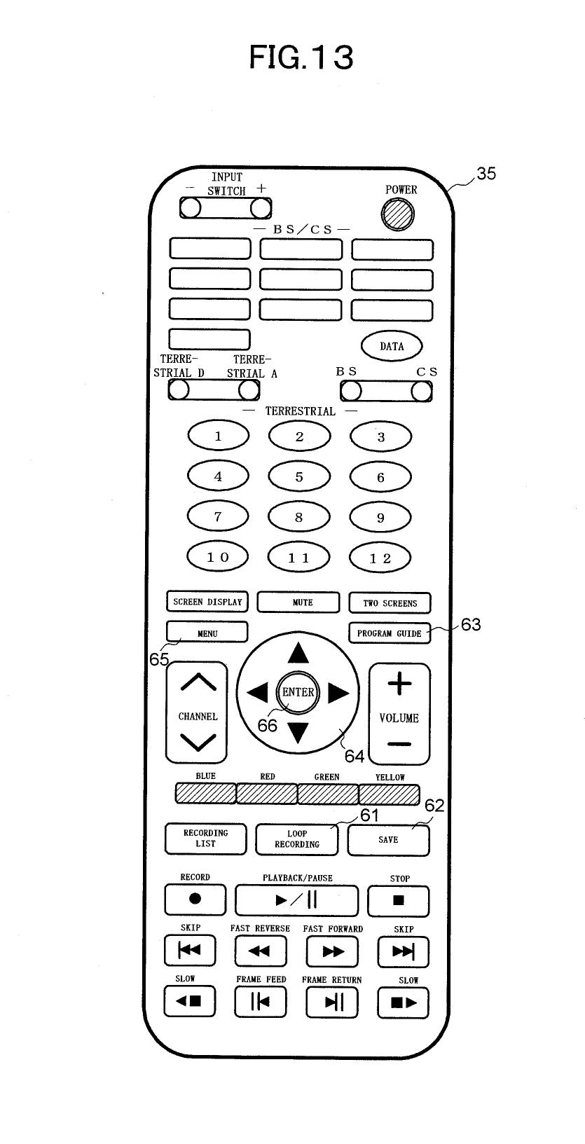

The display unit 34 is a display displaying an operation status of the CPU unit 31 and so on to a user, and is formed by, for example, a LCD element. The key input unit 35 is an input device through which a user's instruction is inputted to the CPU unit 31, and is, for example, a key board, a remote controller, or the like. For example, a remote controller type as shown in FIG. 13 is usable as the key input unit 35.

A recording/reproducing operation of the television system 1 including the recording apparatus 10 of this embodiment will now be described.

In a case of an analog broadcast signal, the analog tuner unit 11 receives analog broadcast waves from the analog antenna A1, and tunes to and demodulates a specific analog broadcast wave, thereby converting the analog broadcast wave into an analog video signal and an analog audio signal, and outputs these signals to the PS encoder unit 12. Upon receipt of the analog video and audio signals, the PS encoder unit 12 A/D-converts these video and audio signals to pack (format) the converted signals, and outputs the packed signals to the data processor unit 13. At this time, the CPU unit 31 generates management information to send the generated management information to the data processor unit 13. The data processor unit 13 records the received video and audio signals together with the management information into the HDD unit 14.

A video signal and an audio signal recorded in the HDD unit 14 are read by the data processor unit 13 to be sent to the PS decoder unit 15. The PS decoder unit 15 separates and decodes packed signals of the read video and audio signals to output them to the selector 16. The selector 16 sends the received signals to the D/A unit 17. The D/A unit 17 D/A-converts the received digital video and audio signals to output the resultant signals to the display D and the speaker SP respectively.

In a case of a digital broadcast signal, the digital tuner unit 21 receives digital broadcast waves from the digital antenna A1, and tunes to and demodulates a specific digital broadcast wave, thereby extracting a digital video signal and a digital audio signal. In a case of a digital broadcast, video and audio have been encoded by a broadcast station and are in an MPEG2-TS signal format. The stream processor unit 22 selects necessary packets from the MPEG2-TS signals and at the same time, converts the TS packets into recording packets to send the packets to the data processor unit 13. The data processor unit 13 records the received data into the HDD unit 14.

A video signal and an audio signal of a digital broadcast wave which are recorded in the HDD unit 14 are read out by the data processor unit 13 to be sent to the TS decoder unit 25. The TS decoder unit 25 separates packed signals of the read video and audio signals to decode them, and outputs the decoded video and audio signals to the selector 16. The selector 16 sends the received signals to the D/A unit 17. The D/A unit 17 D/A-converts the received digital video and audio signals to output the resultant signals to the display D and the speaker SP respectively.

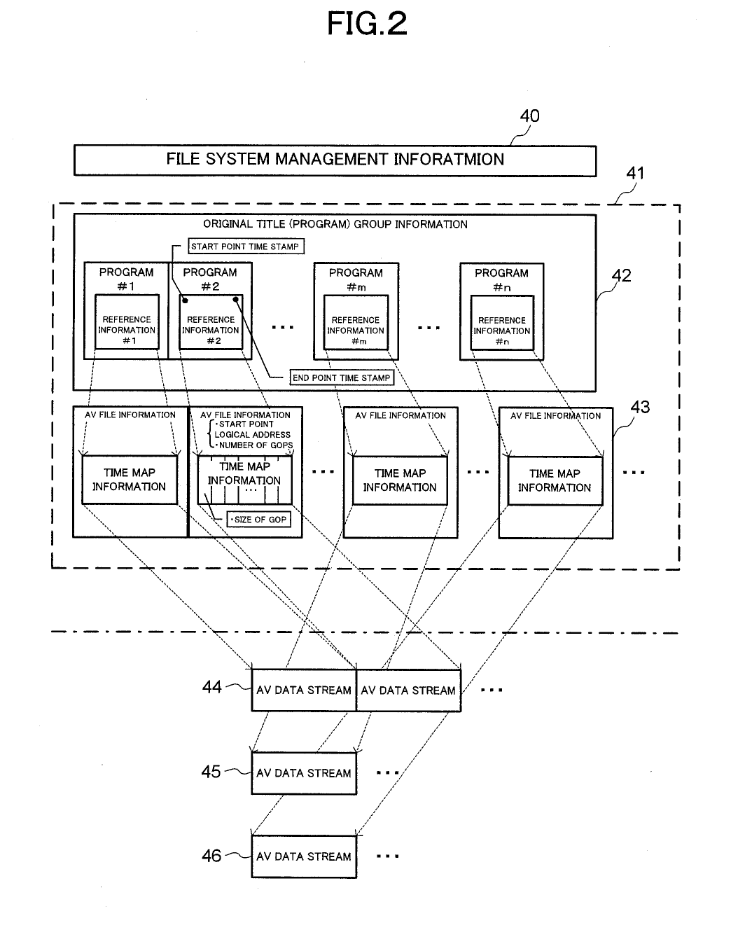

Next, the configuration of data recorded in the HDD unit 14 in the recording apparatus 10 of this embodiment will be described in detail with reference to FIG. 2. FIG. 2 is a schematic chart showing an overview of the data configuration in the recording apparatus 10 of this embodiment.

As shown in FIG. 2, data recorded in the recording apparatus 10 of this embodiment includes file system management information 40, management information 41, a first AV stream file 44, a second AV stream file 45, and a third AV stream file 46, all of which are recorded in the HDD unit 14.

The management information 41 manages position information, attributes, and the like of the recorded data recorded in the HDD unit 14. The management information 41 has program group information 42 and AV file information 43.

The program group information 42 (original title group information) is information (reproduction sequence information) managing reproduction sequence of recorded contents (programs), and pieces of information regarding individual programs are classified on a per program basis. The information regarding each of the programs has reference information linked to AV file information which is information regarding an AV data stream (an aggregate of video and audio data of each program) that is an object to be reproduced. The reference information includes time stamp information indicating a start point and an end point.

The AV file information 43 is a table for linking the program information 42 to be managed by a user, to recorded data that are actually recorded data. The AV file information 43 has time map information indicating information about logical address of a corresponding AV data stream in the HDD unit 14. Specifically, the AV file information has logical address information about a position of a start point of the corresponding AV data stream and information about the number of GOPs (strictly, pieces of information corresponding to the respective GOPs and each indicating the number of data in each of the GOPs) included in the AV file information. The time map information has pieces of information corresponding to the respective GOPs, which are classified on a per GOP basis, and each of pieces of the information has size information on the corresponding GOP. The size of the GOP is expressed by a unit capable of representing the size of the AV data stream, in a recording medium, corresponding to the GOP, and is expressed by, for example, the number of packs, the number of packets, or the number of packet groups each being an aggregate of a plurality of packets.

It is possible to find a time length of an AV data stream, that is, an effective time length of contents whose management information exists, from a difference between the time stamp information on the position of the start point and the time stamp information on the position of the end point in the reference information or from the number of GOPs included in the AV file information. Further, if a specific time position in the management information is known, a GOP existing at the specific time position is determined, and therefore, from the logical address information about the position of the start point included in the AV file information and the size information about the individual GOP, it is possible to find a logical address, in the recording medium, corresponding to this specific time position.

The first to third AV stream files 44 to 46 are data files each including AV data streams corresponding to respective programs (title: a unit a user records at a time). Each of the AV data streams included in the first to third AV stream files 44 to 46 includes an information pack, a video pack, an audio pack, a sub-video pack, and soon. The information pack is an information package for showing attributes of the AV data stream and identifying the AV data stream and includes information indicating a start time at which the first field of the GOP to which the AV data stream belongs is reproduced, information indicating the time when the GOP is recorded, copy control information, and so on. The video pack is an information package including video data compressed in the MPEG2 format, and is composed of a pack header, a packet header, and a video data portion. The audio pack is an information package including audio data processed according to, for example, a format of linear PCM, MPEG, AC-3, or the like, and is composed of a pack header, a packet header, and an audio data portion.

The first AV stream file 44 is a data file prepared for normal recording and reproduction, and the second and third AV stream files 45 and 46 are data files prepared for loop recording. Here, the “normal recording” means recording intended for saving, and the “loop recording” means repeated overwrite-recording into a predetermined area and thus is capable of storing a program only for a predetermined period of time.

The file system management information 40 complies with, for example, a UDF (Universal Disk Format) standard, and manages files in the management information 41 and the first to third AV stream files 44 to 46.

In addition to the program group information 42, play list information made up only of information managing the program reproduction sequence (reproduction sequence information) may be provided. The play list information does not have its own AV data stream and is generated by the edition of (deletion from, addition to) the reference information linked to the AV file information about an original title. Specifically, by editing only the reference information without directly processing an AV data stream, it is possible to generate a program only composed of necessary scenes and to generate a program with unnecessary scenes deleted. FIG. 2 shows an example where the three first to third AV stream files 44 to 46 are prepared, but four stream files or more may be prepared.

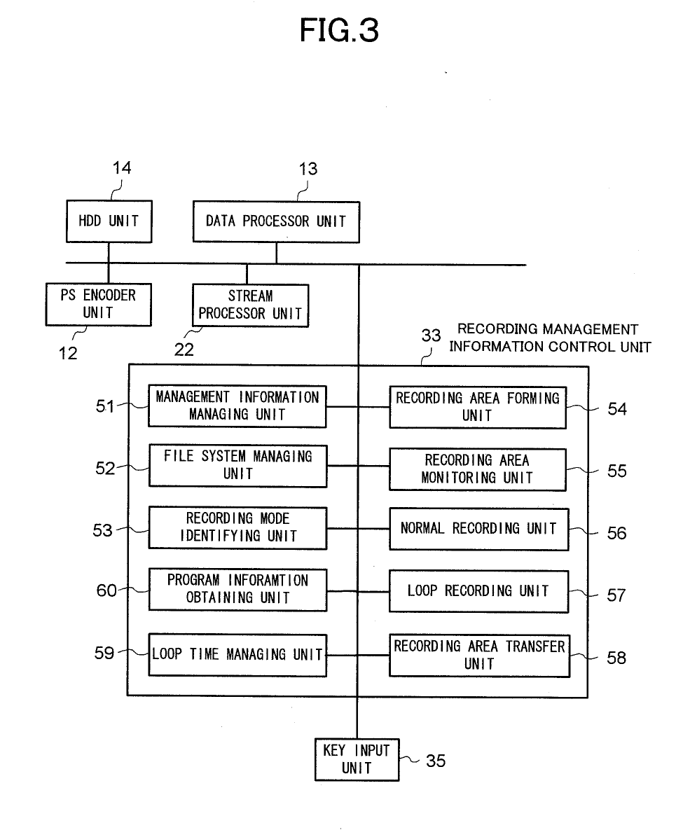

Next, the recording management information control unit 33 in the recording apparatus 10 of this embodiment will be described in detail with reference to FIG. 3. FIG. 3 is a block diagram showing the configuration of the recoding management information control unit 33 shown in FIG. 1. The recording management information control unit 33 has a function of executing a recording operation of the recording apparatus 10 of this embodiment.

As shown in FIG. 3, the recording management information control unit 33 in this embodiment has a management information managing unit 51, a FS managing unit 52, a recording mode identifying unit 53, a recording area forming unit 54, a recording area monitoring unit 55, a normal recording unit 56, a loop recording unit 57, a recording area transfer unit 58, a loop time managing unit 59, and a program information obtaining unit 60. The recording apparatus 10 of this embodiment performs the recording operation by means of the data recording configuration shown in FIG. 2, that is, the configuration in which an AV stream file for normal recording and an AV stream file for loop recording are separated.

The management information managing unit 51 is an information processor managing the program group information 42 and the AV file information 43 shown in FIG. 2. The management information managing unit 51 has a function of providing a user with the program group information recorded in the HDD unit 14 through the display unit 34 and the display D as, for example, “recorded title list” and setting the program group information at the time of recording. The program group information 42 managed by the management information managing unit 51 includes time information regarding each program (time information indicating a position in data recorded in the HDD unit 14). The AV file information 43 managed by the management information managing unit 51 includes logical address information corresponding to the information about a logical position of recorded data.

The FS managing unit 52 is an information processor managing the file system management information 40 complying with, for example, the UDF (Universal Disk Format) standard. In the recording apparatus 10 of this embodiment, a series of recorded data of each program constitutes an AV stream file. The FS management information is information for identifying AV stream files, and the FS managing unit 52 manages the AV stream files through the FS management information.

The recording mode identifying unit 53 is a recording mode manager identifying a recording mode which is instructed by a user via the key input unit 35. The recording modes managed by the recording mode identifying unit 53 include two recording modes, namely, normal recording to perform normal recoding and loop recording to perform repeated overwrite-recording into a predetermined area. The user's instruction may be explicit, or no cancellation may be considered as the instruction. For example, the loop recording may be started upon power-on.

The recording area forming unit 54 is a manager reserving and managing recording areas in the HDD unit 14. The recording area forming unit 54 has a function of reserving recording areas for the first to third AV stream files 44 to 46 in the HDD unit 14 in advance or setting the reserved recording areas free.

The recording area monitoring unit 55 is a monitor for monitoring the recording areas reserved by the recording area forming unit 54. The recording area monitoring unit 55 has a function of monitoring the recording areas reserved by the recording area forming unit 54 to notify the monitoring result to the normal recording unit 56 or the loop recording unit 57.

The normal recording unit 56 is a processor executing normal recording processing, and has a function of instructing the data processor unit 13 to normally record, into the HDD unit 14, video data and audio data sent from the PS encoder unit 12 or the stream processor unit 22.

The loop recording unit 57 is a processor executing loop recording processing. The loop recording unit 57 has a function of instructing the data processor unit 13 to loop-record, into the HDD unit 14, video data and audio data sent from the PS encoder unit 12 or the stream processor unit 22.

The recording area transfer unit 58 is a data transferer logically transferring data recorded as an AV data stream to/from the AV stream files. The recording area transfer unit 58 has a function of transferring a later-described predetermined area between chapters from the second and third AV stream files 45 and 46, to which data have been recorded, to the first AV stream file 44. The transfer between the AV stream files is realized by a change in logical address, and therefore, is not actual transfer of a recorded location. This realizes higher processing speed than simple transfer processing of the AV data stream.

The loop time managing unit 59 is a manager managing a loop time of loop recording executed by the loop recording unit 57. The loop time managing unit 59 sets the loop time in advance based on a setting instruction accepted via the key input unit 35. The loop time managing unit 59 also has a function of dynamically changing the loop time based on program time information obtained from the program information about a program to be recorded. The loop time (standard loop time) set in advance can be, for example, 30 minutes, 60 minutes, 90 minutes, and so on.

The program information obtaining unit 60 has a function of reading the program information about a program to be loop-recorded (or program information about a currently loop-recorded program), from the program information managed by the program information processing unit 36 and sending, to the loop time managing unit 59, the start time information, the end time information, the time length information, and so on of the program to be loop-recorded.

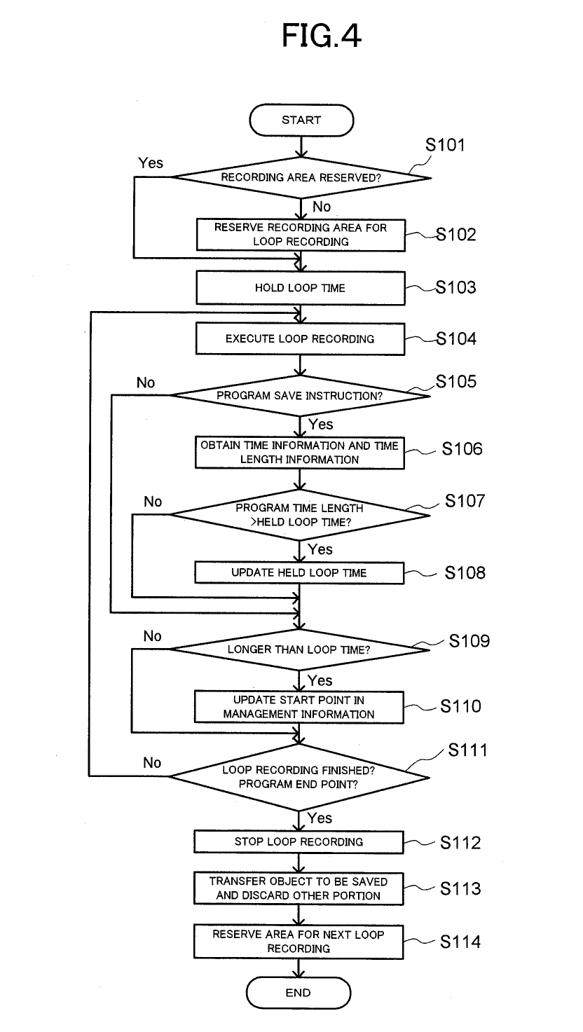

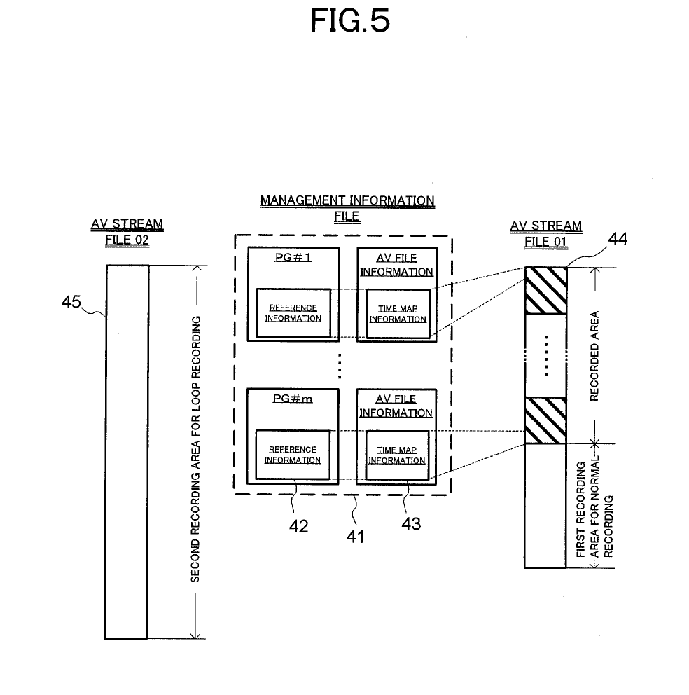

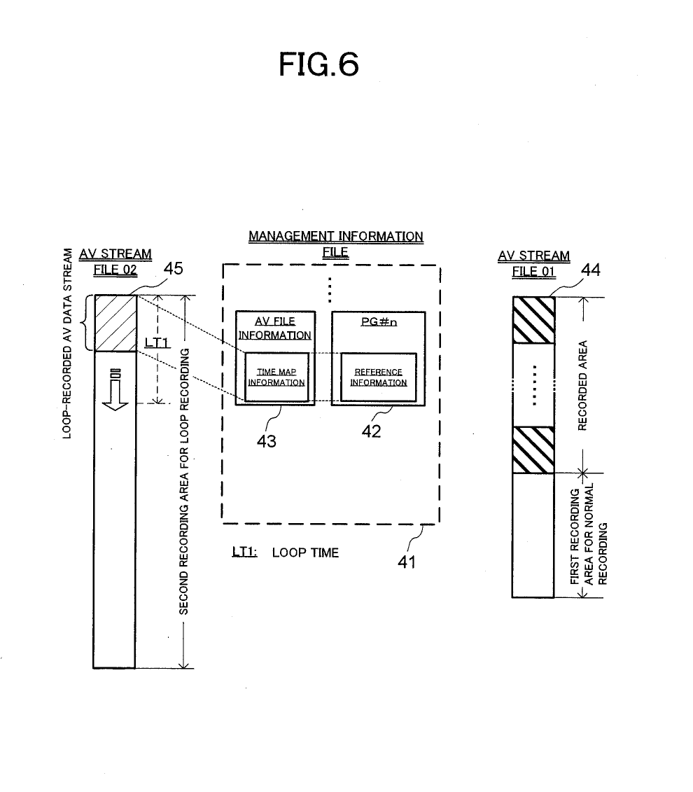

Next, the operation of the recording apparatus 10 of this embodiment will be described with reference to FIG. 4 to FIG. 12. FIG. 4 is a flowchart showing a recording operation of the recording apparatus 10 of this embodiment, FIG. 5 is a schematic chart showing a state of normal recording in this embodiment, and FIG. 6 to FIG. 12 are schematic charts showing a recording operation of loop recording of this embodiment. FIG. 6 to FIG. 12 show how the management information file and the AV stream files change during the loop recording processing of the recording apparatus 10 of this embodiment. This embodiment is an example where the recording apparatus 10 includes the first AV stream file 44 and the second AV stream file 45 among those shown in FIG. 2.

First, the initial states of the management information 41, the first AV stream file 44, and the second AV stream file 45 are shown in FIG. 5. Here, a first recording area for normal recording is reserved in the first AV stream file 44 used for normal recording. A second recording area for loop recording is reserved in the second AV stream file 45 used for loop recording. In the example shown in FIG. 5, as the program group information 42 of programs recorded through normal recording, titles PG#1 to PG#m have already been recorded and recoded areas have been formed in the first AV stream file 44 (areas diagonally hatched by bold lines in FIG. 5), but they are sometimes omitted in the description below for convenience sake of description.

As shown in FIG. 5, the management information 41 comprehensively manages AV data streams recorded in the two AV stream files 44 and 45. That is, the AV data streams are managed by the single management information file irrespective of whether their recording destination is the first AV stream file 44 or the second AV stream file 45.

Further, when an AV data stream is recorded in the second AV stream file 45 through loop recording, an area into which the AV data stream has been recorded is transferred from the second AV stream file 45 to the first AV stream file 44 after the stop of the loop recording, so as to match the reproduction sequence. For example, in a case where a file system complying with the UDF (Universal Disk Format) standard is used, an extent corresponding to the area, in the second AV stream file 45, into which the AV data stream has been recorded through loop recording is transferred from a file entry of the second AV stream file 45 to a file entry of the first AV stream file 44. More specifically, descriptions of the file entries of the first and second AV stream files 44 and 45 are changed so that the extent indicated by the file entry of the second AV stream file 45 is indicated by the file entry of the first AV stream file 44. In this manner, the first AV stream file 44 not only is used as a recording destination for normal recording but also functions as an archive file for saving contents recorded through loop recording.

In this embodiment, a recording area in the second AV stream file 45 used for loop recording is reserved prior to the start of the recording so as to have a sufficiently large size. For example, let us assume that the specification of the recording apparatus 10 of this embodiment defines that the maximum settable loop time as the recording time is one hour. If a value up to the maximum settable one hour is a standard value of the loop time, a recording area having a size large enough to record contents longer than the standard value is reserved in the second AV stream file 45. Though the size depends on recording quality (compression ratio, bit rate, or the like), it is preferable to reserve a size large enough to record, with an allowance, a relatively long program having a length of about several hours. Not only the length of a program but also a transfer rate of broadcast signals should be taken into consideration, and therefore, if the standard value is set under the assumption of, for example, a situation where an AV data stream of the highest possible bit rate in the standard of a digital broadcast continues for a long time, a recording area of a size with a relatively large allowance can be reserved.

Next, the operation of loop recording will be described in detail. When a user gives a loop recording instruction by, for example, pressing a loop recording button 61 of the key input unit 35 shown in FIG. 13, the recording mode identifying unit 53 receiving the instruction instructs the loop recording unit 57 to execute loop recording processing. Upon receipt of the loop recording instruction, the loop recording unit 57 makes an inquiry to the recording area monitoring unit 55 as to whether or not a recording area for loop recording has been reserved (Step 101)(hereinafter, referred to as “S101” and the like). Upon receipt of the inquiry, the recording area monitoring unit 55 makes an inquiry to the FS managing unit 52 as to whether the recording area for loop recording has been reserved in the first AV stream file 44 or the second AV stream file 45. Since loop recording is assigned to the second AV stream file 45 in this example, the FS managing unit 52 notifies in reply, a file system where the second AV stream file 45 exists, as a file system for loop recording. The recording area monitoring unit 55 determines whether or not the recording area for loop recording (hereinafter, referred to as “a second recording area”) has been reserved in the second AV stream file 45 in the file system which is notified by the FS managing unit 52 in reply, and notifies the result of the determination to the loop recording unit 57 in reply.

If the result of the determination shows that the second recording area has not been reserved (No at S101), the loop recording unit 57 instructs the recording area forming unit 54 to reserve the second recording area. The recording area forming unit 54 forms the second recording area in the second AV stream file 45 in the HDD unit 14 and notifies logical addresses of its start and end points to the loop recording unit 57 in reply (S102). Here, as the second recording area, the recording area forming unit 54 reserves an area having a size large enough to record contents whose time length is longer than the maximum possible loop time defined by the specification of the recording apparatus 10. For example, this size is set large enough to record three-hour contents under the setting of the highest definition and the lowest compression ratio (or the setting of the highest transfer bit rate). This is because the length of a television program is generally about two hours. Of course, this is only an example, and the size may be set large enough to record four-hour contents or longer.

After the recording area is reserved, the loop recording unit 57 generates the management information 41 in the initial state, which is a state at the recording start time, to hold the generated management information 41 in an internal memory. Specifically, the loop recording unit 57 instructs the management information managing unit 51 to generate the management information 41 pertaining to the whole contents to be recorded, among the program group information 42, the reference information, and the AV file information 43. Upon receipt of the instruction, the management information managing unit 51 receives, from the loop recording unit 57, logical addresses of a start point and an end point of the second recording area which have been notified from the recording area forming unit 54, and sets these logical addresses as the time map information included in the AV file information 43.

After the management information 41 is generated, the loop time managing unit 59 sets a predetermined value of the standard loop time as a loop time LT1 to hold the loop time LT1 (S103). The standard loop time is determined, for example, in consideration of the standard length of a television broadcast program and the capacity of the HDD unit 14, and for example, is set to thirty minutes, one hour, one hour and a half, or the like based on a user's selection.

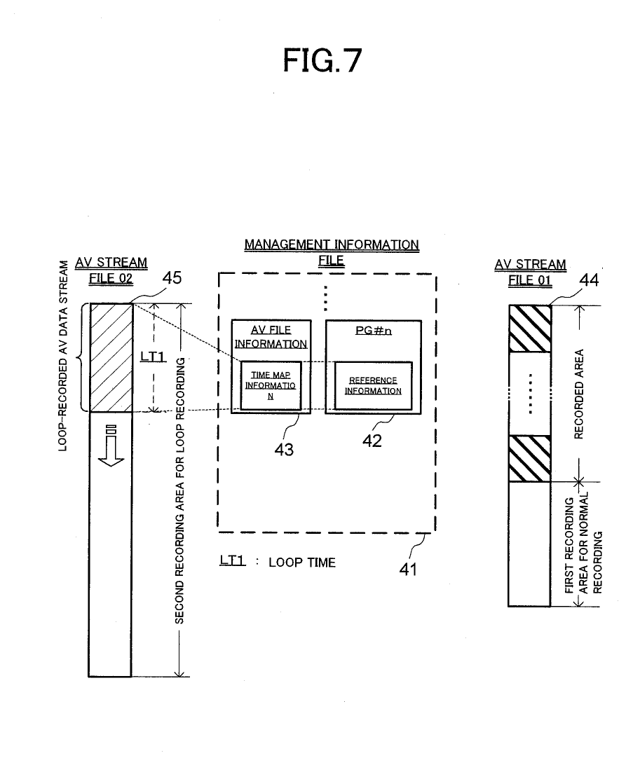

After the loop time is set, the loop recording unit 57 records video data and audio data sent from the PS encoder unit 12 or the stream processor unit 22, into the second recording area reserved in the second AV data stream file 45 in the HDD unit 14 (S104). Incidentally, during the recording into the second recording area, the management information managing unit 51 generates, from moment to moment, the time map information reflecting the progress of the recording of an AV data stream to record the time map information into the AV file information 43 in the memory. FIG. 6 shows a state where the loop recording into the second recording area in the second AV stream file 45 is underway. In FIG. 6, contents are loop-recorded as a new title PG#n. As shown in FIG. 6, the AV data stream (portion diagonally hatched by fine lines) to be loop-recorded is recorded in the second recording area, and the time map information as the management information corresponds to the AV data stream recorded in the second recording area. In the state shown in FIG. 6, the loop time LT1 has not passed after the start of the loop recording. FIG. 7 shows a state where the loop recording into the second AV stream file 45 has progressed a little further from the state shown in FIG. 6, that is, the state where exactly the loop time LT1 has passed from the start of the loop recording.

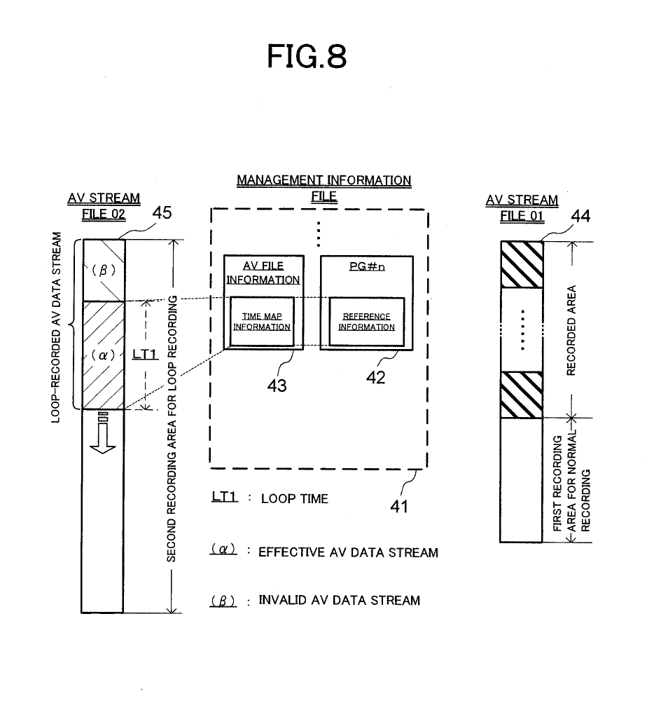

FIG. 8 shows a state where the loop recording into the second. AV stream file 45 has further progressed. The recording of the AV data stream into the second AV stream file 45 has further progressed, and the end point indicated by the time map information included in the management information 41 shows a logical address of a recording progress position of the AV data stream. The time corresponding to this recording progress position is written as the time stamp information about the end point included in the reference information. The start point indicated by the time map information included in the management information 41 is updated so as to indicate a logical address of a position that is apart backward by the standard loop time LT1 from the recording progress position of the AV data stream, and the time corresponding to the updated position is written as the new time stamp information about the start point in the reference information. That is, in the state in FIG. 8, in the management information 41, only a portion corresponding to the length of the standard loop time LT1 from the recording progress position of the AV data stream is left, and the management information older than this left portion is discarded. A portion (α) in the second AV stream file 45 is an effective AV data stream indicated by the left management information 41 corresponding to the length of the standard loop time LT1. On the other hand, a (β) portion in the second AV stream file 45 is an invalid AV data stream whose management information has been already discarded. When the loop recording progresses and a seek of the second AV stream file 45 takes place, a new AV data stream is overwritten on the (β) portion.

Here, upon receipt of a program save instruction that a user gives by, for example, pressing the save button 62 of the key input unit 35 shown in FIG. 13 (Yes at S105), the program information obtaining unit 60 receives, from the program information processing unit 36, the program information regarding the currently loop-recorded program, and obtains the start time information and end time information of the program, the time length information of the program, and so on. The program information obtaining unit 60 sends the obtained time information and time length information to the loop time managing unit 59.

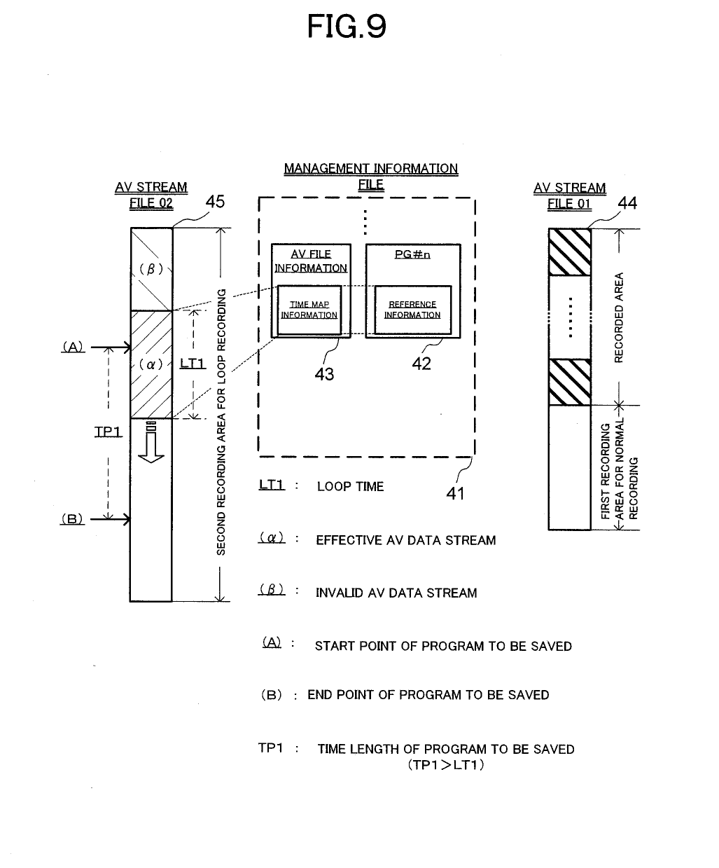

FIG. 9 shows a state where the save instruction of a program is given from the user. When the save instruction of the program is given via the key input unit 35, the program information obtaining unit 60 reads, from the program information processing unit 36, the program information used for displaying the EPG (Electronic Program Guide) screen to obtain information such as the start time and end time of the program designated as an object to be saved, the time length of the program, and the like. A time distance to a start point or an end point of the program to be saved is found from a difference between the obtained start time or the end time of the program and the time at which the save operation is performed, this time being obtained from a clock provided in the recording/reproducing apparatus. Based on the time distance, by evaluating the time stamp information about the start point/end point in the reference information included in the management information, the number of GOPs in the time map information included in the management information, and so on (they are updated from moment to moment as the loop recording progresses), it is possible to find where the start point and end point of the program to be saved are located in the management information 41 in terms of time, and therefore, by referring to the corresponding time map information, logical addresses of the start point and end point of the program to be saved can be found. In the example in FIG. 9, the logical addresses of the positions of the start and end points of the program to be saved are (A) and (B) respectively, and the time length of the program to be saved is TP1. Further, the time length TP1 of the program to be saved has a larger value than the standard loop time LT1. The logical addresses of the positions of the start and end points of the program to be saved can be obtained from the program information.

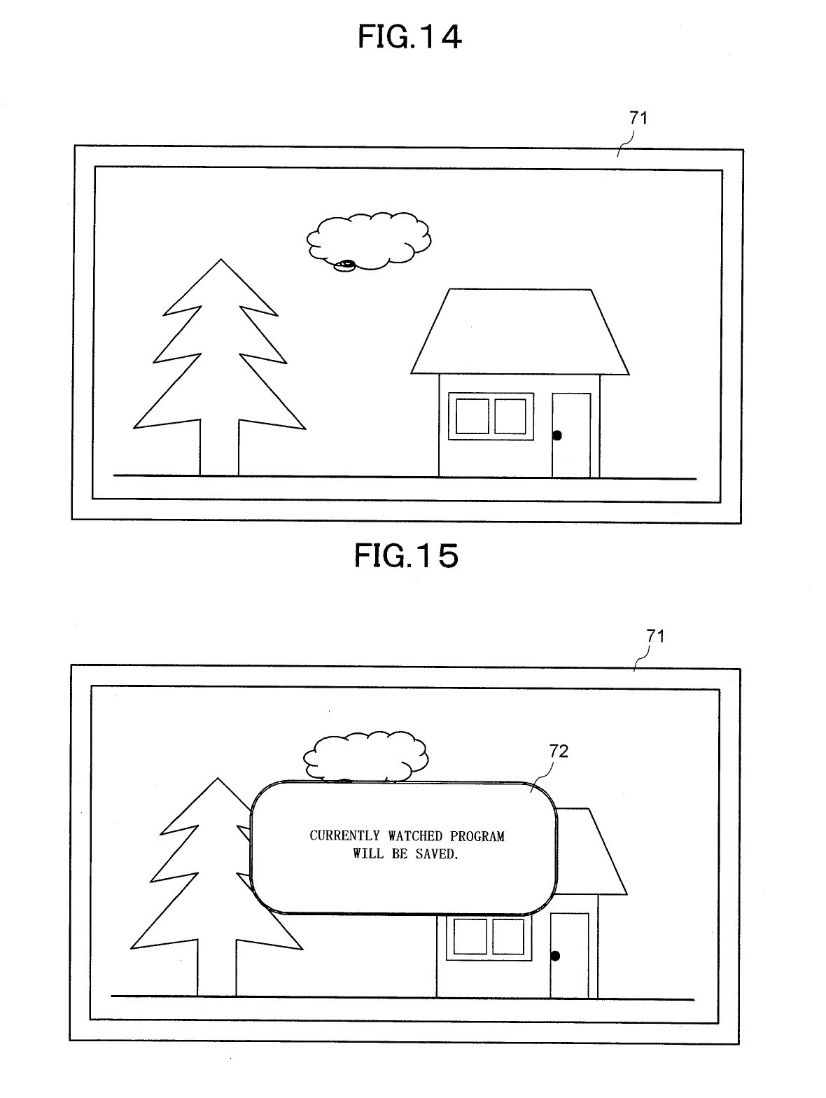

Here, states of a save instruction given via the key input unit 35 and the display D will be described with reference to FIG. 14 to FIG. 19. FIG. 14 and FIG. 15 show states of a save instruction a user gives while watching a program. An image 71 of the currently watched program is displayed on the display D. When the save instruction is given via the key input unit 35 shown in FIG. 13, the management information managing unit 51 displays on the display D a message 72 saying “the currently watched program will be saved”. This is an example where a currently watched program is saved.

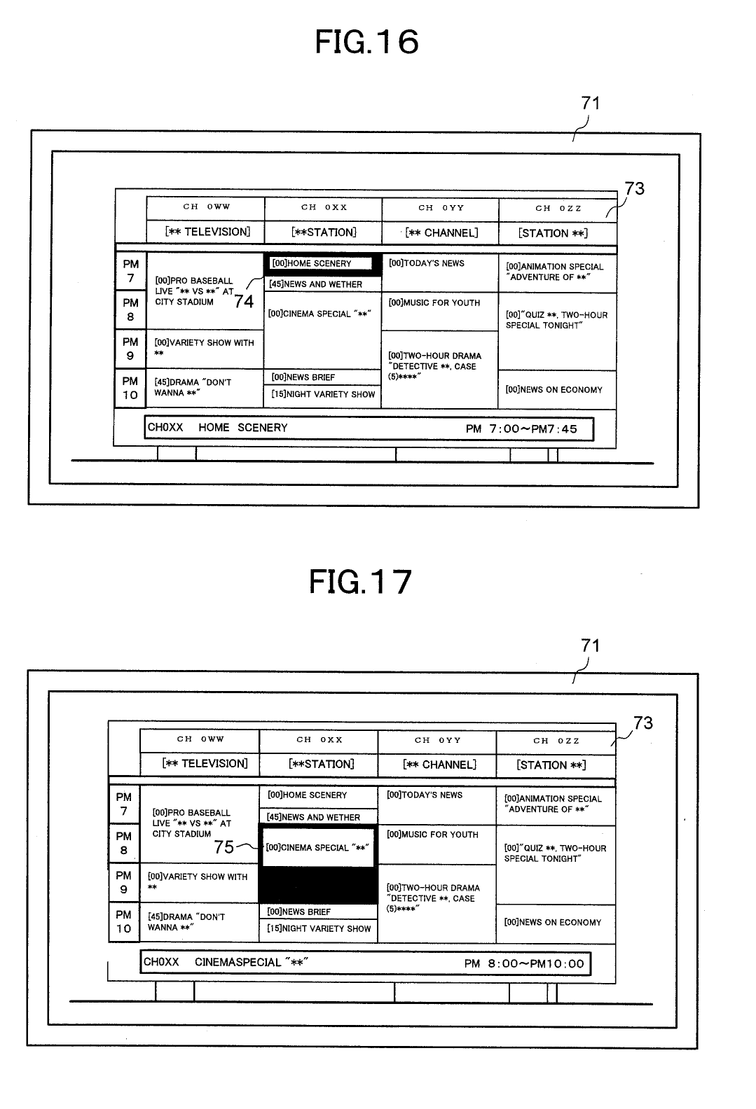

FIG. 16 to FIG. 19 show an example where a save instruction is given while the management information managing unit 51 displays, on the display D, the EPG information obtained by the program information processing unit 36. FIG. 16 shows contents displayed on the display D when the EPG (Electronic Program Guide) screen is displayed. In response to a user's operation of a program guide button 63 of the remote-control type key input unit 35 shown in FIG. 13, the management information managing unit 51 displays an EPG display 73 on the display D. At this moment, a focus 74 resides on a currently loop-recorded program in the EPG display 73.

FIG. 17 shows contents displayed on the display D when a program to be saved is selected on the EPG display 73. In this embodiment, as a program to be saved, not only a program currently watched and loop-recorded but also a program broadcast at a later time can be selected. In the example shown in FIG. 17, in response to a user's operation of a cursor button 64 of the remote-control type key input unit 35 shown previously in FIG. 13, the focus 75 is shifted onto a program broadcast at a later time by the same broadcast station that is broadcasting the currently loop-recorded program.

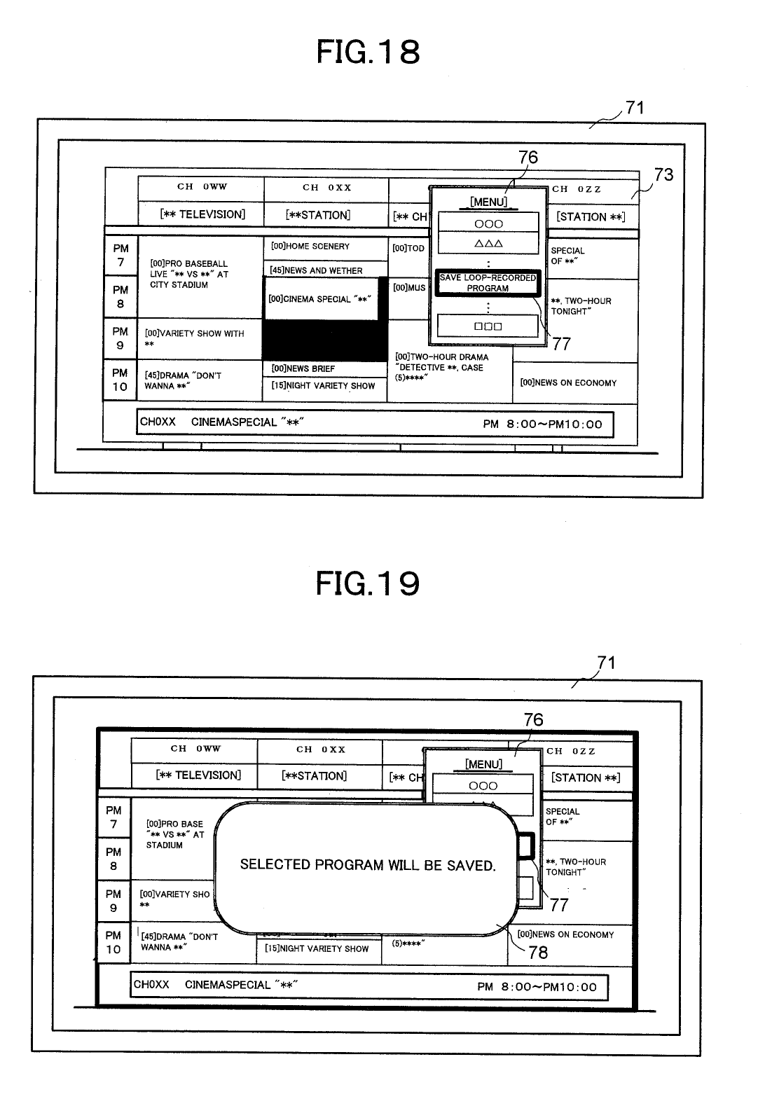

Next, FIG. 18 shows a state of a television screen when a menu for a program save operation is called. In the example in FIG. 18, in response to a user's operation of a menu button 65 of the remote-control type key input unit 35 previously shown in FIG. 13, a menu window 76 is displayed. Subsequently, by a user's operation of the cursor button 64 of the key input unit 35 shown in FIG. 13, a menu for saving the program to be loop-recorded is selected, and a focus 77 resides on the menu. Finally, FIG. 19 shows contents displayed on the display D when the save operation of the program by the user is executed. Here, in response to a user's operation of an enter button 66 of the key input unit 35 shown previously in FIG. 13, a program save function selected on the menu window shown in FIG. 19 is executed and a message 78 is displayed.

Upon receipt of the time information and the time length information, the loop time managing unit 59 compares the time length of the currently loop-recorded program with the loop time held by itself (S107). When the time length of the currently loop-recorded program is longer than the held loop time (Yes at S107), the loop time managing unit 59 updates the loop time to the time length of the currently loop-recorded program as a new loop time (S108). Consequently, even if the time length of the program corresponding to the received program save instruction is longer than the initially set standard loop time, the whole program can be recorded. Incidentally, the loop time managing unit 59 may set, as the new loop time, the time length longer than the time length of the currently loop-recorded program. Consequently, recording with an allowance in a recording area can be realized.

Subsequently, the loop time managing unit 59 compares an effective time length of the currently loop-recorded contents, which is obtained from the management information 41, with the held loop time (S109). That is, the time length after the start of the loop recording is compared with the loop time.

When the effective time length of the currently loop-recorded contents is longer than the loop time (Yes at S109), the loop time managing unit 59 instructs the loop recording unit 57 to update the start point in the management information 41 to a position that is apart backward in terms of time by the time length of the held loop time from the current recording progress position. Upon receipt of the instruction, the loop recording unit 57 validates only the management information corresponding to a portion from the current recording progress position to the position backward by the time length of the loop time, and discards an older portion of the management information (S110). Specifically, the loop recording unit 57 deletes the time map information corresponding to the discarded portion, and updates the management information so that the time stamp about the start point in the reference information linked to this time map information is shifted to the backward position of the contents in terms of time. Consequently, the AV data stream corresponding to the discarded management information becomes inaccessible to be an invalid AV data stream. When the loop recording further progresses to reach an end of the second AV stream file 45, the loop recording unit 57 executes a seek of a file pointer and overwrite-records a new AV data stream into the area in which this invalid AV data stream is recorded. This processing retains at least the AV data stream corresponding to the loop time (the time length at least equal to or longer than the time length of the program in a case where the save instruction is received), and the recording of contents corresponding to the loop time (or the time length of the program for which the save instruction is given) can be ensured.

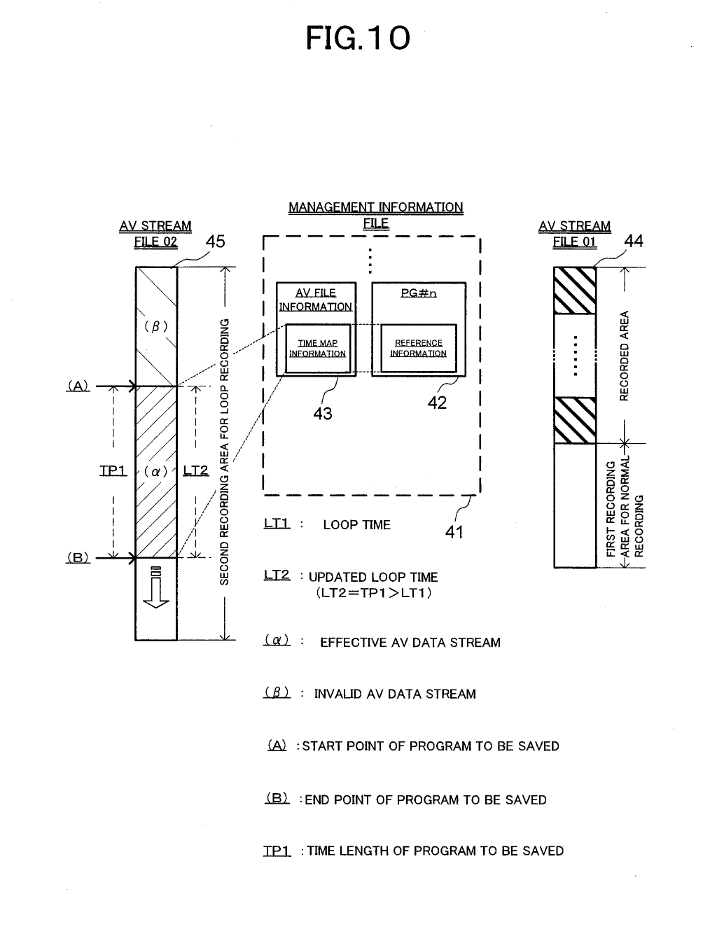

FIG. 10 shows a state when the loop recording has further progressed. In a case where the user's save instruction of a program is given and the comparison result shows that the time length of the currently loop-recorded program is longer than the loop time, the loop time is updated from the standard loop time LT1 to a loop time LT2 set equal to the time length TP1 of the program to be saved. Consequently, the length of contents for which the management information 41 is left is increased to the new loop time LT2, so that the AV data stream of the whole program whose time length exceeds the standard loop time LT1 can be effectively recorded. FIG. 10 shows a state where the loop recording has progressed up to the end point of the program to be saved.

During the recording processing by the loop recording unit 57, the recording area monitoring unit 55 monitors a state of the second recording area into which the loop recording unit 57 executes the recording, and notifies the monitoring result to the loop recording unit 57 (S111). Specifically, based on the time map information generated by the management information managing unit 51, the recording area monitoring unit 55 finds a position up to which the AV data stream has been recorded in the recording medium (in the second AV stream file 45), and compares the found position with the held standard loop time (or the time length corresponding to the program for which the save instruction is given), thereby determining whether or not the loop recording has reached the end point.

If a portion being recorded by the loop recording unit 57 is the end point of the program (Yes at S111), the loop recording unit 57 stops the loop recording (S112). Here, the recording of the AV data stream into the second AV stream file 45 is stopped and the update processing of the management information 41 such as the generation of the time map information is also stopped.

After the loop recording is stopped, the recording area transfer unit 58 transfers the area into which the AV data stream corresponding to the program to be saved has been recorded, from the second AV stream file 45 to the first AV stream file 44 which is an archive file (S113). For example, in a case where a file system complying with the UDF (Universal Disk Format) standard is used, the recording area transfer unit 58 transfers an extent corresponding to the area into which the AV data stream corresponding to the program to be saved has been recorded, from a file entry of the second AV stream file 45 to a file entry of the first AV stream file 44. More specifically, descriptions of the file entries of the first AV stream file 44 and the second AV stream file 45 are changed so that the extent indicated by the file entry of the second AV stream file 45 is indicated by the file entry of the first AV stream file 44.

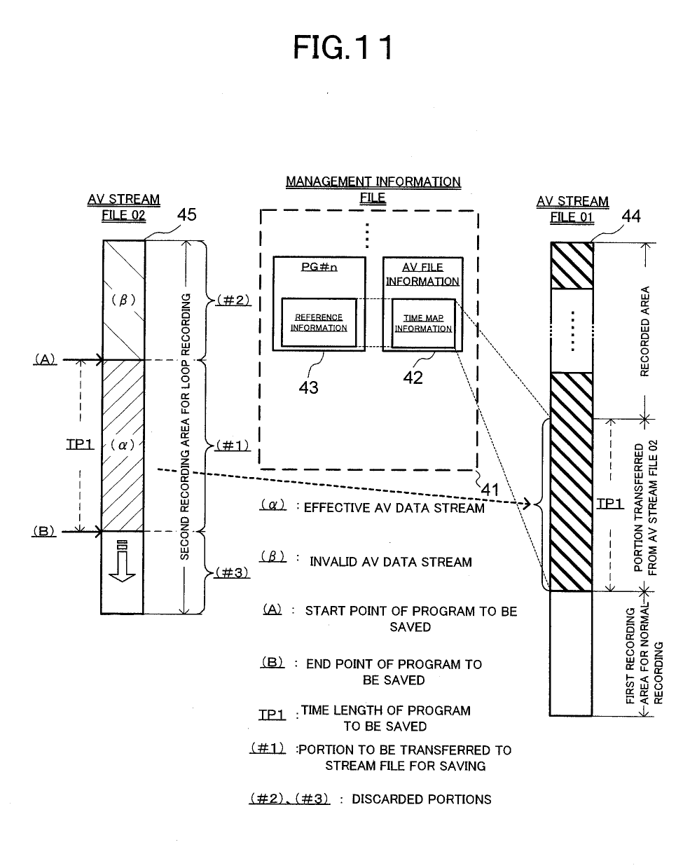

FIG. 11 shows a state where the loop recording has reached the end point of the program to be saved and is stopped. The contents to be saved are transferred from the second AV stream file 45 to the first AV stream file 44 for normal recording which is an archive file. Specifically, a recording area (#1) corresponding to the program to be saved is transferred from the second AV stream file 45 to the first AV stream file 44. For example, in a case where a file system complying with the UDF (Universal Disk Format) standard is used, an extent corresponding to the area (#1) in which the AV data stream (α) corresponding to the program to be saved is recorded is transferred from the file entry of the second AV stream file 45 to the file entry of the first AV stream file 44. More specifically, descriptions of the file entries of the first and second AV stream files 44, 45 are changed so that the extent indicated by the file entry of the second AV stream file 45 is indicated by the file entry of the first AV stream file 44. Accordingly, the time map information regarding the contents PG#n is also changed so as to indicate a logical address in the first AV stream file 44 for normal recording which is a transfer destination. Incidentally, areas (#2) and (#3) which are not objects to be transferred are set free, and will be re-used for the next loop recording.

Here, in the case of loop recording, there may be a case where an area having the recorded AV data stream corresponding to the program to be saved exist dividedly as a first half and a latter half in a tail portion and a head portion of the recording area in the second AV stream file 45 respectively. In this case, at the time of the transfer from the second AV stream file 45 to the first AV stream file 44 by the recording area transfer unit 58, the sequence of these portions after the transfer has to match the reproduction sequence. In addition, the recording area transfer unit 58 discards the AV data stream not corresponding to the program to be saved (data stream not falling within the standard loop time and thus made inaccessible). This is intended to set free the area in which the AV data stream other than the object to be transferred is recorded, and to reuse it for the next recording. At the time of this transfer processing, the recording area transfer unit 58 changes the time map information included in the management information 41 so that the time map information indicates the logical address information in the first AV stream file 44. Therefore, the management information stored in the memory is written to the management information file after the transfer processing is finished.

Finally, the recording area forming unit 54 makes the setting again so that the second AV stream file 45 has a vacant area with a predetermined capacity to be usable as a new recording destination file for the next loop recording. This process is the same as that of Step S102 previously described.

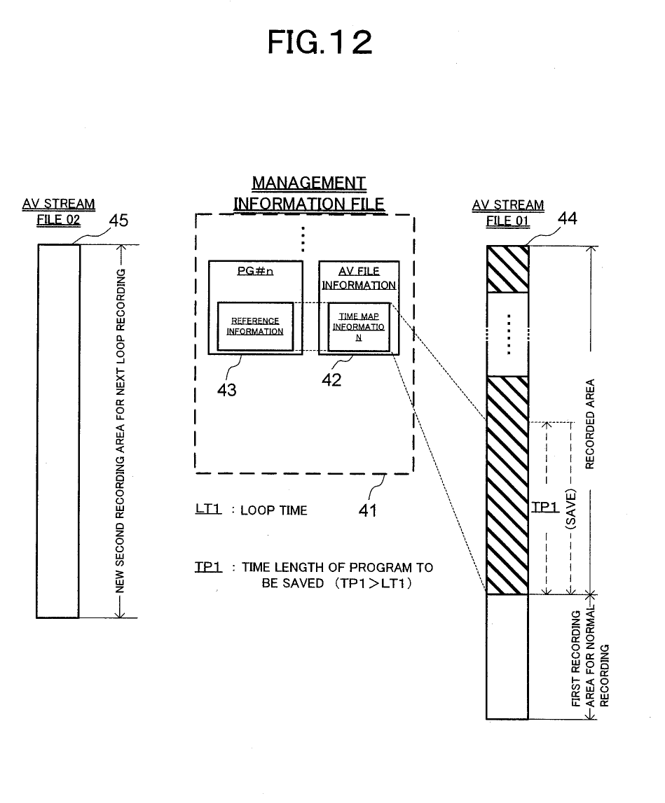

FIG. 12 shows a state after the completion of the transfer of the extent of the area in which the program to be saved is recorded. Here, in preparation for new loop recording, a vacant area with a predetermined capacity is reserved in the second AV stream file 45 whose recorded contents have been saved.

Incidentally, in a case where the user performs the save operation of the program via the key input unit 35 at the aforesaid Step S105, the recording of the program to be saved begins at the start time obtained at the subsequent Step S106, but in a case where the time length of the program to be saved is longer than the pre-set standard value of the loop time and the user performs the save operation of the program after a considerably long time has passed from the start of the program to be saved, a first half portion of the program to be saved may have already been lost by the aforesaid processing at Step S110. That is, in a case where the program is considerably longer than the standard loop time and the save instruction is performed on the final stage of the program, the head portion of the program might not be recorded. In such a case, a portion after the start point indicated by the management information left at this moment (the head position of contents left as loop-recorded contents) is the program to be saved, and a portion shorter than the time length of the original program to be saved is saved. In such a case, a warning to that effect may be displayed on the display D when the save operation of the program is performed by the user at Step 105.

Further, at the aforesaid Step S111, the loop recording is automatically stopped when it is determined that the loop recording has reached the end point of the program to be saved, but such an operation is not restrictive. For example, an alert maybe displayed when the loop recording progresses close to the end point of the program to be saved, thereby promoting a user to perform a manual operation for stopping the loop recording.

Further, in FIG. 9, the method of calculating the position of the start point and the position of the end point of the program to be saved is described, but the method of calculating the position of the start point and the position of the end point of the program to be saved is not limited to the method described here and may be other method. For example, the position of the start point and the position of the end point of the program to be saved can be roughly found from the time distance to the start point and the end point of the program to be saved described in FIG. 9 and the transfer rate of the AV data stream (which is calculated in consideration of an encoding rate of video obtained from the MPEG2 stream and an amount of codes of audio and data broadcast). Another possible method is, for example, as follows: Every time the start point and the end point of a currently loop-recorded program are obtained from the management information of a digital broadcast multiplexed on a MPEG2-TS signal, logical addresses of positions to which the start point and the end point of the program are recorded are stored as a separate table, and when the save instruction of a program is performed, the logical address of the start point of the program to be saved is obtained from this table, and the end point of the program to be saved is determined based on the end time obtained from the program information.

As described above, according to the recording apparatus 10 of this embodiment, the management information managing unit 51 manages the management information for normal recording and management information for loop recording by means of the program group information 42 and AV file information 43 which are common to normal recording and loop recording, and therefore, the management information can be provided to a user as the program information without any distinction between normal recording and loop recording.

Further, according to the recording apparatus 10 of this embodiment, a relatively large area is reserved as the loop recording area, and therefore, even if a save instruction of a currently loop-recorded program is given during loop recording, the program can be recorded in its entirety. Further, according to the recording apparatus 10 of this embodiment, since the loop time for loop recording is extendable according to the time length or the like of a program, a program whose time length is long can be recorded irrespective of user's setting. Further, according to the recording apparatus 10 of this embodiment, since it is possible to dynamically shift the start point of the loop recording based on the obtained program information regarding a currently loop-recorded program, it is possible to effectively use the loop recording area by setting an unnecessary recording area free.

### SECOND EMBODIMENT

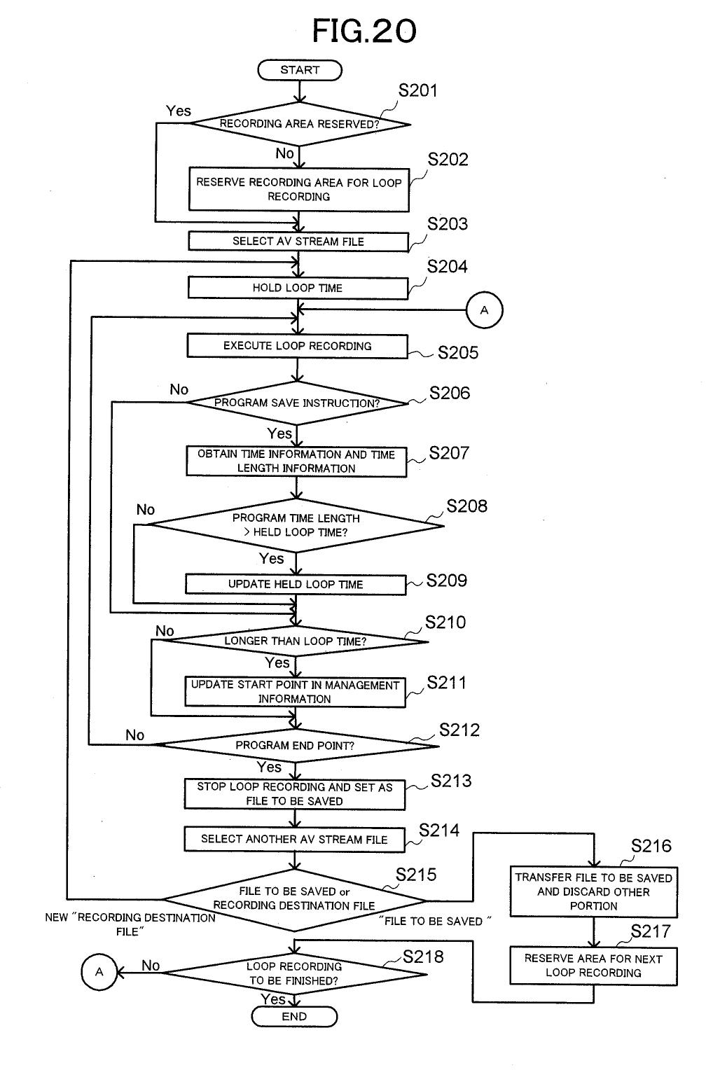

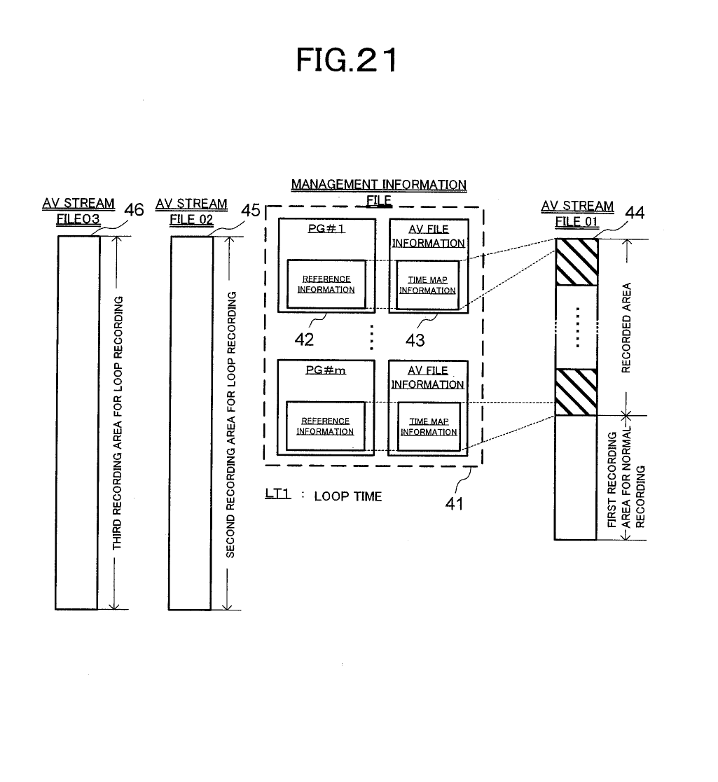

Next, a recording apparatus according to another embodiment of the present invention will be described with reference to FIG. 20 to FIG. 28. FIG. 20 is a flowchart showing a loop recording operation of a recording apparatus according to a second embodiment of the present invention, and FIG. 21 to FIG. 28 are schematic charts showing the loop recording operation of the same. The recording apparatus of the second embodiment has the same configuration as that of the recording apparatus of the first embodiment shown in FIG. 1 and FIG. 3, but is different in that it includes a plurality of loop recording areas. Therefore, redundant description will be omitted.

In this embodiment, by using two AV stream files, in the course of loop recording into one of the AV stream files, the transfer of a recording area from the other AV stream file to a first AV stream file 44 as an archive file takes place, thereby realizing the saving of contents. In the second embodiment as in the first embodiment, recording areas of a second AV stream file 45 and a third AV stream file 46 which are used for loop recording are reserved so as to have a sufficiently large size prior to the start of the recording.

FIG. 21 shows initial states of management information 41, the first AV stream file 44, the second AV stream file 45, and the third AV stream file 46. Here, a first recording area for normal recording is reserved in the first AV stream file 44 used for normal recording. A second and a third recording area for loop recording are reserved in the second AV stream file 45 and the third AV stream file 46 used for loop recording. In the example shown in FIG. 21, as program group information 42 regarding programs recorded through normal recording, titles PG#1 to PG#m have already been recorded, and recorded areas are formed in the first AV stream file 44.

As shown in FIG. 21, the management information 41 comprehensively manages AV data streams recorded in the three AV stream files. That is, the AV data streams are managed by the single management information file irrespective of whether their recording destination is the first AV stream file 44, the second AV stream 45 file, or the third AV stream file 46.

When an AV data stream is recorded into the second or third stream file 45 or 46 through loop recording, a recorded area into which the AV data stream is recorded is transferred from the second or third AV stream file 45 or 46 to the first AV stream file 44 after the loop recording is stopped, so as to match the reproduction sequence. For example, in a case where a file system complying with the UDF (Universal Disk Format) standard is used, an extent corresponding to the area in the second or third AV stream file 45 or 46 into which the AV data stream has been recorded through loop recording is transferred from a file entry of the second or third AV stream file 45 or 46 to a file entry of the first AV stream file 44. More specifically, descriptions of the file entries of the first AV stream file 44 and the second or third AV stream files 45 or 46 are changed so that the extent indicated by the file entry of the second or third AV stream file 45 or 46 is indicated by the file entry of the first AV stream file 44. In this manner, the first AV stream file 44 not only is used as a recording destination of normal recording but also functions as an archive file for storing contents recorded through loop recording.

In this embodiment, recording areas of the second and third AV stream files 45 and 46 used for loop recording are also reserved prior to the start of the recording so as to have a sufficiently large size. For example, let us assume that the specification of the recording apparatus 10 of this embodiment defines that the maximum settable loop time as the recording time is one hour. If a value up to the maximum settable one hour is a standard value of the loop time, a recording area having a size large enough to record contents longer than the standard value is reserved in the second or third AV stream file 45 or 46. Though the size depends on recording quality (compression ratio, bit rate, or the like), it is preferable to reserve a size large enough to record, with an allowance, a relatively long program having a length of about several hours. Not only the length of the program but also a transfer rate of broadcast signals should be taken into consideration, and therefore, if the standard value is set under the assumption of, for example, a situation where an AV data stream of the highest possible bit rate in the standard of a digital broadcast continues for hours, the recording area of a size with a relatively large allowance can be reserved.

Next, the operation of loop recording will be described in detail. When a user gives a loop recording instruction by, for example, pressing the loop recording button 61 of the key input unit 35 shown in FIG. 13, the recording mode identifying unit 53 receiving the instruction instructs the loop recording unit 57 to execute loop recording processing. Upon receipt of the loop recording instruction, the loop recording unit 57 makes an inquiry to the recording area monitoring unit 55 as to whether or not a recording area for loop recording has been reserved (S201). Upon receipt of the inquiry, the recording area monitoring unit 55 makes an inquiry to the FS managing unit 52 as to in which one of the first to third AV stream files 44 to 46 the recording area for loop recording has been reserved. In this example, since loop recording is assigned to the second and third AV stream files 45 and 46, the FS managing unit 52 notifies in reply, a file system where the second or third AV stream file 45 or 46 exists, as a file system for loop recording. The recording area monitoring unit 55 determines whether or not the recording area for loop recording (hereinafter, referred to as “a second recording area” or “a third recording area”) has been reserved in the second or third AV stream file 45 or 46 in the file system notified by the FS managing unit 52 in reply, and notifies the result of the determination to the loop recording unit 57 in reply (Here, the description will be given on assumption that the second recording area is reserved in the second AV stream file 45).

If the result of the determination shows that the second or third recording area has not been reserved (No at S201), the loop recording unit 57 instructs the recording area forming unit 54 to reserve the second recording area. The recording area forming unit 54 forms the second recording area in the second AV stream file 45 in the HDD unit 14 and notifies logical addresses of its start and end points to the loop recording unit 57 in reply (S202). Here, the recording area forming unit 54 reserves an area having a size large enough to record contents whose time length is longer than the maximum possible loop time defined by the specification of the recording apparatus 10. For example, this size is set large enough to record three-hour contents under the setting of the highest definition and the lowest compression ratio (or the setting of the highest transfer bit rate). This is because that the length of a television program is generally about two hours. Of course, this is only an example, and the size may be set large enough to record four-hour contents or longer.

After the recording area is reserved, the loop recording unit 57 selects the second AV stream file 45 as the recording area for loop recording and generates the management information 41 in the initial state, which is a state at the recording start time, to hold the generated management information 41 in an internal memory (S203). Specifically, the loop recording unit 57 instructs the management information managing unit 51 to generate the management information 41 pertaining to the whole contents to be recorded, among the program group information 42, the reference information, and the AV file information 43. Upon receipt of the instruction, the management information managing unit 51 receives, from the loop recording unit 57, logical addresses of a start point and an end point of the second recording area which have been notified from the recording area forming unit 54, and sets these logical addresses as the time map information in the AV file information 43.

After the management information 41 is generated, the loop time managing unit 59 sets a predetermined value of the standard loop time as a loop time LT1 to hold the loop time LT1 (S204). The standard loop time corresponds to the length of a program of a television broadcast and is determined in consideration of the capacity of the HDD unit 14, and for example, is set to thirty minutes, one hour, one hour and a half, or the like based on a user's selection.

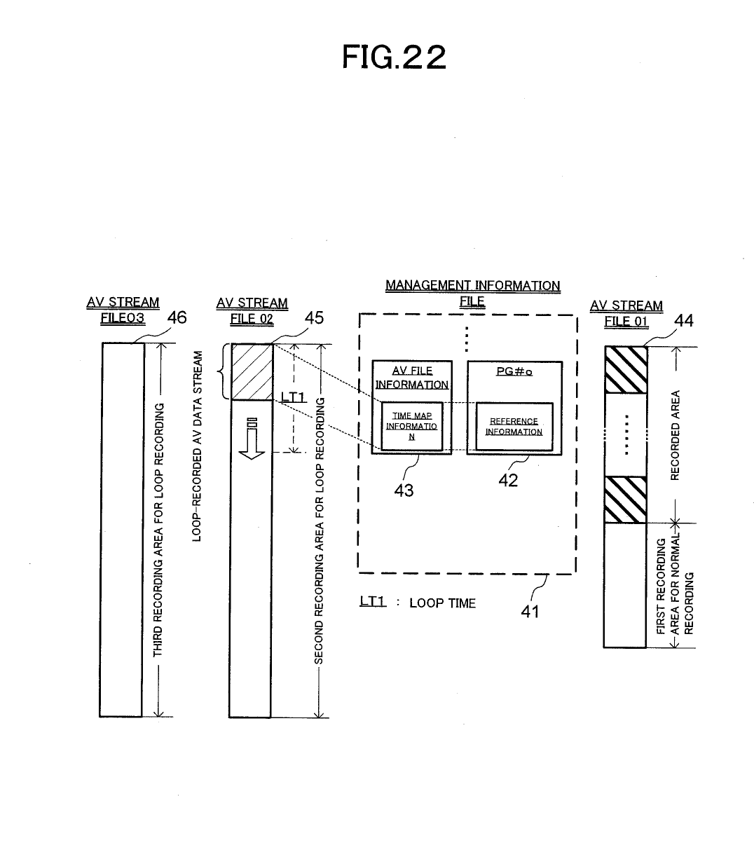

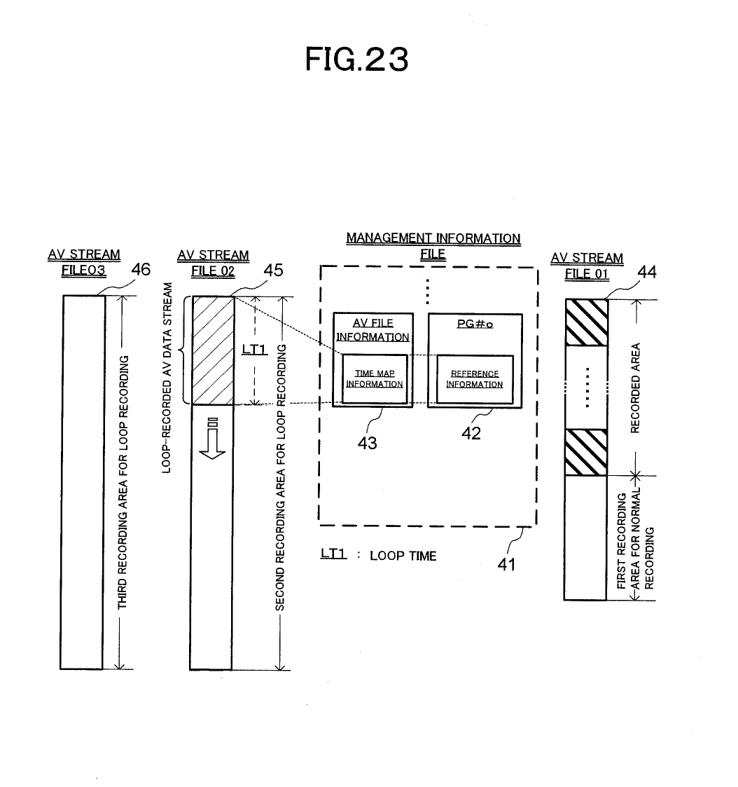

After the loop time is set, the loop recording unit 57 records video data and audio data sent from the PS encoder unit 12 or the stream processor unit 22, into the second recording area reserved in the second AV data stream file 45 in the HDD unit 14 (S205). Incidentally, during the recording into the second recording area, the management information managing unit 51 generates, from moment to moment, the time map information reflecting the progress of the recording of an AV data stream to record the time map information into the AV file information 43 in the memory. FIG. 22 shows a state where the loop recording into the second recording area in the second AV stream file 45 is underway. In FIG. 22, contents are loop-recorded as a new title PG#0. As shown in FIG. 22, the AV data stream (portion diagonally hatched by fine lines) to be loop-recorded is recorded in the second recording area, and the time map information as the management information corresponds to the AV data stream recorded in the second recording area. In the state shown in FIG. 22, the loop time LT1 has not passed after the start of the loop recording. FIG. 23 shows a state where the loop recording into the second AV stream file 45 has progressed a little further from the state shown in FIG. 22, more specifically, the state where exactly the loop time LT1 has passed from the start of the loop recording.

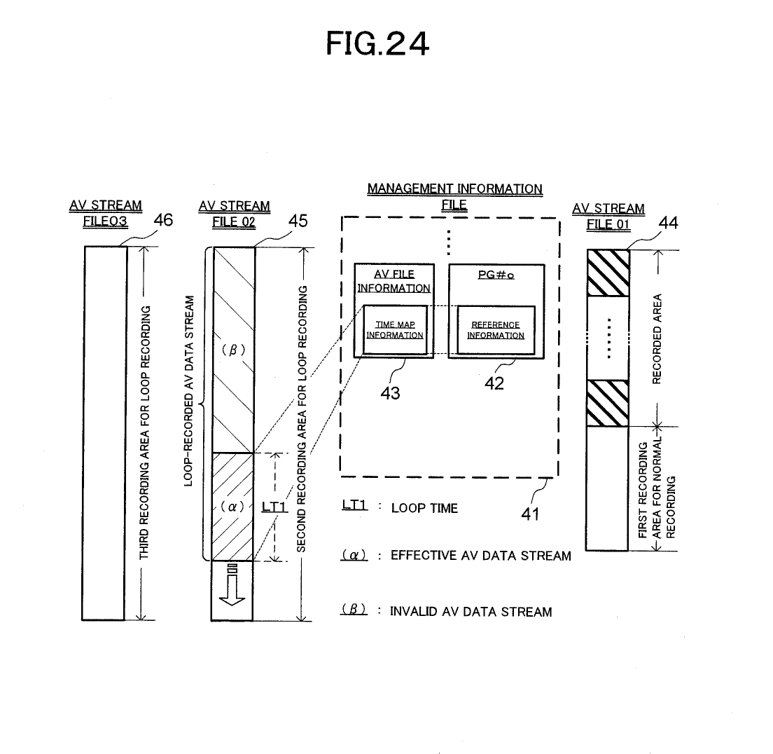

FIG. 24 shows a state where the loop recording into the second AV stream file 45 has further progressed. This example shows a state where the loop time is not updated and the standard loop time LT1 is held. The recording of the AV data stream into the second AV stream file 45 has further progressed, and the end point indicated by the time map information included in the management information 41 shows a logical address of a recording progress position of the AV data stream. The time corresponding to the recording progress position is written as the time stamp information about the end point in the reference information. The start point indicated by the time map information included in the management information 41 is updated so as to indicate a logical address of a position that is apart backward by the standard loop time LT1 from the recording progress position of the AV data stream, and the time corresponding to the updated position is written as the new time stamp information about the start point in the reference information. That is, in the state in FIG. 24, in the management information 41, only a portion corresponding to the length of the standard loop time LT1 from the recording progress position of the AV data stream is left, and the management information older than this left portion is discarded. A portion (α) in the second AV stream file 45 is an effective AV data stream indicated by the left management information 41 corresponding to the length of the standard loop time LT1. On the other hand, a (β) portion in the second AV stream file 45 is an invalid AV data stream whose management information has been already discarded. When the loop recording progresses and a seek of the second AV stream file 45 takes place, a new AV data stream is overwritten on the (β) portion.

Here, upon receipt of a program save instruction that a user gives by, for example, pressing the save button 62 of the key input unit 35 shown in FIG. 13 (Yes at S206), the program information obtaining unit 60 receives, from the program information processing unit 36, the program information about the currently loop-recorded program, and obtains the start time information and end time information of the program, the time length information of the program, and so on (S207). The program information obtaining unit 60 sends the obtained time information and time length information to the loop time managing unit 59.

Upon receipt of the time information and the time length information, the loop time managing unit 59 compares the time length of the currently loop-recorded program with the loop time held by itself (S208). If the time length of the currently loop-recorded program is longer than the loop time (Yes at S208), the loop time managing unit 59 updates the loop time to the time length of the currently loop-recorded program (S209). Consequently, even if the time length of a program corresponding to the received program save instruction is longer than the initially set standard loop time, the whole program can be recorded. Incidentally, as in the first embodiment, the loop time managing unit 59 may set, as the new loop time, a time length longer than the time length of the currently loop-recorded program. Consequently, recording with an allowance in a recording area can be realized.

Subsequently, the loop time managing unit 59 compares an effective time length of the currently loop-recorded contents, which is obtained from the management information 41, with the held loop time (S210). That is, the time length after the start of the loop recording is compared with the loop time.

If the effective time length of the currently loop-recorded contents is longer than the loop time (Yes at S210), the loop time managing unit 59 instructs the loop recording unit 57 to update the start point in the management information 41 to the position that is apart backward in terms of time by the time length of the held loop time from the current recording progress position. Upon receipt of the instruction, the loop recording unit 57 validates only the management information corresponding to a portion from the current recording progress position to the position backward by the time length of the loop time, and discards an older portion of the management information (S211). Specifically, the loop recording unit 57 deletes the time map information corresponding to the discarded portion, and updates the management information so that the time stamp about the start point in the reference information linked to this time map information is shifted to the backward position of the contents in terms of time. Consequently, the AV data stream corresponding to the discarded management information becomes inaccessible to be an invalid AV data stream. When the loop recording further progresses to reach an end of the second AV stream file 45, the loop recording unit 57 executes a seek of a file pointer and overwrite-records a new AV data stream file into the area in which this invalid AV data stream is recorded. This processing retains at least an AV data stream file corresponding to the loop time (the time length at least equal to or longer than the program time length in a case where the save instruction is received), and the recording of contents corresponding to the loop time (or the time length of the program for which the save instruction is given) can be ensured.

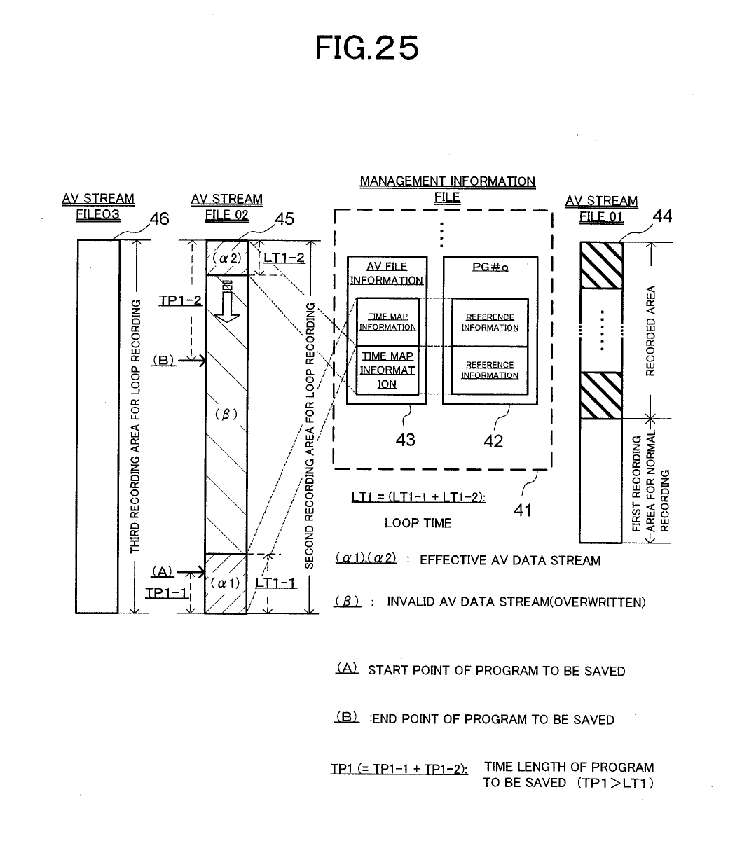

FIG. 25 shows a state where a save instruction of a program is given by a user. In the example in FIG. 25, a recording progress position has reached the end of the second AV stream file 25, and thus a seek of the file pointer takes place and an AV data stream is overwrite-recorded into the area having the invalid recorded AV data stream file whose management information has been deleted. Therefore, the effective AV data stream file whose management information is left is dividedly recorded as a first half portion (α1) and a latter half portion (α2). The time length corresponding to the left management information 41 is the standard loop time LT1, and in FIG. 25, the time length corresponding to (α1) is defined as LT1-1 in the management information, and the time length corresponding to (α2) is defined as LT1-2 in the management information, and the relation LT1=LT1-1+LT1-2 holds. In this example, the reference information and the time map information are prepared for each of the separately recorded AV data stream files (α1) and (α2), but a set of the reference information and the time map information may correspond comprehensively to the both.

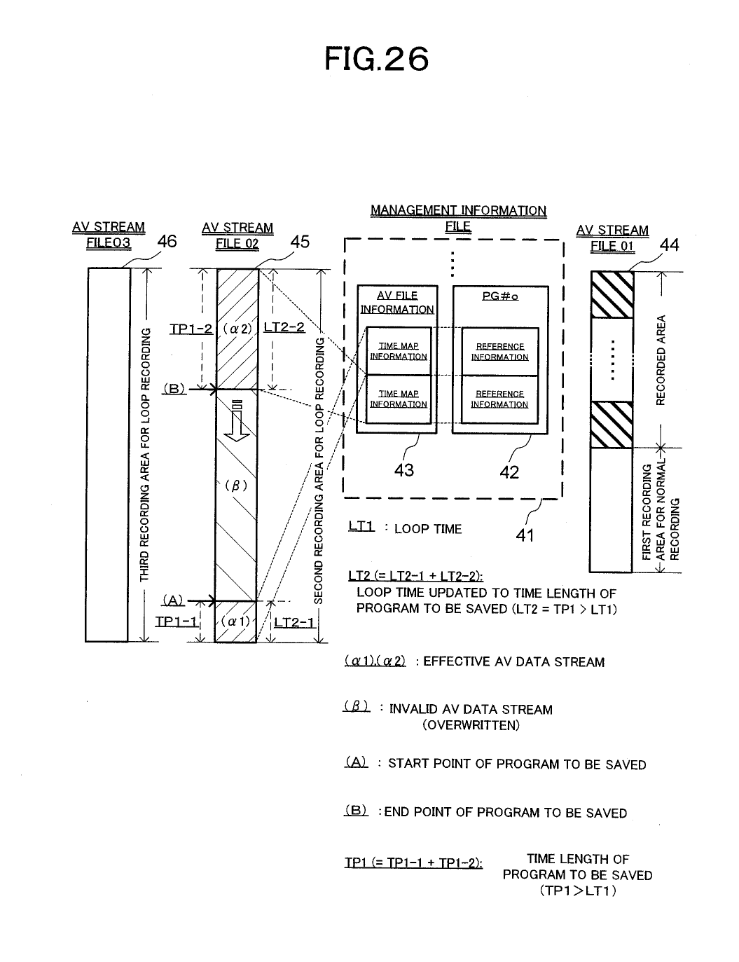

FIG. 26 shows a state where the loop recording has further progressed. After the save operation of the program is given from the user, the loop time is updated from the standard loop time LT1 to a loop time LT2 based on the time length of the program to be saved. Here, the time length of (α1) in the management information is LT2-1, and the time length (α2) in the management information is LT2-2, and the relation LT2=LT2-1+LT2-2 holds. Consequently, the length corresponding to the left management information is increased to the loop time LT2, so that the AV data stream file of the whole program whose time length exceeds the standard loop time LT1 can be made effective.

During the recording processing by the loop recording unit 57, the recording area monitoring unit 55 monitors a state of the second recording area into which the loop recording unit 57 executes the recording, and notifies the monitoring result to the loop recording unit 57 (S212). Specifically, based on the time map information generated by the management information managing unit 51, the recording area monitoring unit 55 finds a position up to which the AV data stream file has been recorded in the recording medium (in the second AV stream file 45), and compares the found position with the held standard loop time (or the time length corresponding to the program for which the save instruction is given), thereby determining whether or not the loop recording has reached the end point.

If a portion being recorded by the loop recording unit 57 is the end point of the program (Yes at S212), the loop recording unit 57 stops the loop recording (S213). Here, the recording of the AV data stream into the second AV stream file 45 is stopped and the update processing of the management information 41 such as the generation of the time map information is also stopped, and the loop-recorded portion is set as a file to be saved.

The loop recording unit 57 selects the third AV stream file 46 as the recording area of the loop recording, and generates the management information 41 in the initial state, which is a state at the recording start time, to hold the generated management information in the internal memory (S214). Consequently, the loop recording thereafter is executed not into the second AV stream file 45 into which the loop recording has been executed so far, but into the third AV stream file 46.

After the loop recording is stopped, the recording area transfer unit 58 transfers the area into which the AV data stream corresponding to the file to be saved (program to be saved) has been recorded, from the second AV stream file 45 to the first AV stream file 44 which is an archive file (S215/S216). For example, in a case where a file system complying with the UDF (Universal Disk Format) standard is used, the recording area transfer unit 58 transfers an extent corresponding to the area into which the AV data stream corresponding to the program to be saved has been recorded, from a file entry of the second AV stream file 45 to a file entry of the first AV stream file 44. More specifically, descriptions of the file entries of the first AV stream file 44 and the second AV stream file 45 are changed so that the extent indicated by the file entry of the second AV stream file 45 is indicated by the file entry of the first AV stream file 44.

Along with Step S216, the loop time managing unit 59 sets a predetermined value of the standard loop time as the loop time LT1 and holds the loop time LT1 (S215/S204). After the loop time is set, the loop recording unit 57 records video data and audio data sent from the PS encoder unit 12 or the stream processor unit 22, into the third recording area reserved in the third AV data stream file 46 in the HDD unit 14 (S205). Thereafter, the loop recording is continued.

The recording area forming unit 54 sets a vacant area with a predetermined capacity in the second AV stream file 45 again, so that the second AV stream file 45 becomes usable as a new recording destination file for the next loop recording (S217).

If the loop recording processing is to be continued, the flow returns to Step 205, where the loop recording unit 57 continues the loop recording (No at S218/“A”).

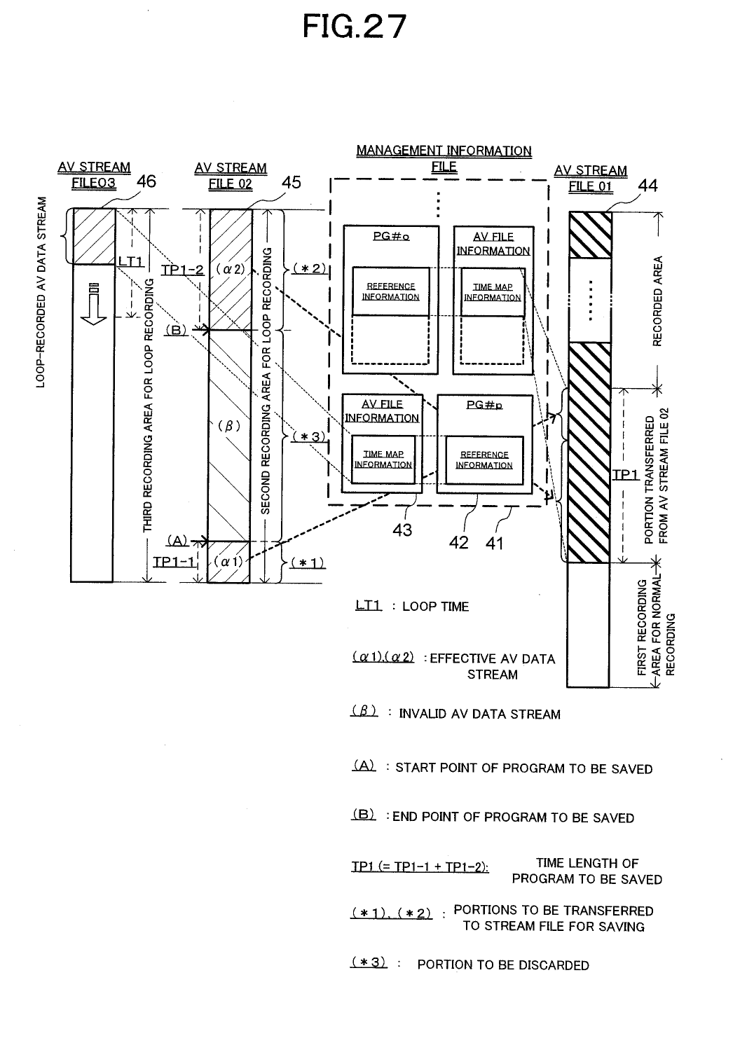

FIG. 27 shows a state when the loop recording has reached the end point of the program to be saved. Here, the loop recording into the second AV stream file 45 is stopped, and the loop recording is continued and executed into the third AV stream file 46 which is a new recording destination file after the change. Along with the loop recording, performed in parallel is the transfer of the contents to be saved which is defined as the file to be saved and thus should be saved in the first AV stream file 44 for normal recording from the second AV stream file 45. Concretely, recording areas (*1) and (*2) corresponding to the program to be saved are transferred from the second AV stream file 45 to the first AV stream file 44. In a case where a file system complying with the UDF (Universal Disk Format) standard is used, extents corresponding to the areas (*1) and (*2) in which the AV data streams (α1) and (α2) corresponding to the program to be saved are recorded are transferred from a file entry of the second AV stream file 45 to a file entry of the first AV stream file 44. More specifically, descriptions of the file entries of the first AV stream file 44 and the second AV stream file 45 are changed so that the extents indicated by the file entry of the second AV stream file 45 are indicated by the file entry of the first AV stream file 44. Accordingly, the time map information of the contents PG#0 is also changed so as to indicate a logical address in the first AV stream file 44 for normal recording which is a transfer destination. An area (*3) which is not an object to be transferred is set free, and will be re-used for the next loop recording. At the time of this transfer, the sequence of the extents corresponding to the areas (*1) and (*2) in which the AV data streams (α1) and (α2) corresponding to the program to be saved are recorded is changed so as to match the time sequence of the contents and so that these extents have contiguous logical addresses, and thereafter, these extents are transferred to the first AV stream file 44 for normal recording which is the transfer destination. Accordingly, the management information is also changed so that a set of the reference information and the time map information corresponding to the title PG#0 indicates the contiguous portions to which the AV data streams (*1) and (*2) are transferred.

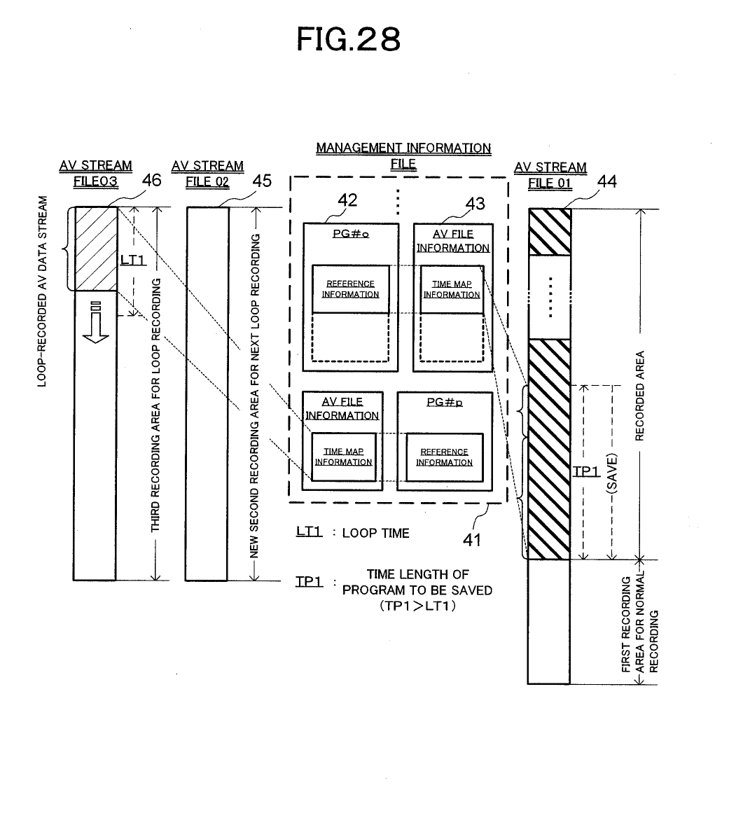

FIG. 28 shows a state after the completion of the transfer of the extents of the areas in which the program to be saved is recorded. Here, in preparation for new loop recording, a vacant area with a predetermined capacity is reserved in the second AV stream file 45 after the save processing of the contents is finished. Along with this processing, the loop recording into the third AV stream file 46 is continuously executed.

Here, as shown in FIG. 26, there may be a case where an area in which the AV data stream corresponding to the program to be saved is recorded exist dividedly as a first half and a latter half in a tail portion and a head portion of the recording area in the second AV stream file 45 respectively. In this case, in transferring these portions from the second AV stream file 45 to the first AV stream file 44, the sequence of the portions after the transfer has to match the reproduction sequence. In addition, at Step S216, the AV data stream not corresponding to the program to be saved is discarded. This is intended to set free the area in which the AV data stream other than the object to be transferred is recorded, and to reuse it for the next recording. At the time of this transfer processing, the time map information included in the management information is changed so as to indicate the logical address information in the first AV stream file 44. Therefore, the management information stored in the memory is written to the management information file after the transfer processing is finished. However, the loop recording into the third AV stream file 46 is being executed in parallel at this moment, and therefore, in a practical viewpoint, it is thought to be appropriate that the write to the management information file comes after the end of the loop recording into the third AV stream file 46 which is under parallel execution.

In a case where the save instruction of the program is given from the user at Step S206, the recording of the program to be saved begins at the start time obtained at the next Step S207, but in a case where the time length of the program to be saved is longer than the preset standard loop time and the user performs the save operation of the program after a considerably long time has passed from the start of the program to be saved, a first half portion of the program to be saved may possibly have been lost due to the processing at Step S211. In this case, a portion after the start point indicated by the management information left at this moment is the program to be saved, and a portion shorter than the time length of the original program to be saved is saved. In such a case, a warning to that effect (that part of the program to be saved is not saved) may be displayed when the save instruction of the program is received at Step S206.

In the above description, in a case where it is determined at Step S212 that the loop recording has reached the end point of the program to be saved, the processing at subsequent Step S213 and Step S214 are executed to newly set a recording destination file, and the loop recording is resumed by newly executing the processing at and after Step S204 into this new recording destination file, but to simplify the structure, the following simple procedure may be adopted: [1] the loop recording into the first recording destination file is stopped, [2] the recording destination file is changed, and [3] the loop recording is resumed into the new recording destination file. Further, for example, a buffer capacity of the AV stream data may be set larger so that defective video, which is caused due to the change of the recording destination file, is reduced to a minimum. Further, the defective video due to the change of the recording destination file may be prevented in such a manner that the loop recording into the new recording destination file is started earlier than the timing when the loop recording into the first recording destination file is stopped, and the loop recording into the first recording destination file is continued in parallel for a while thereafter, thereby providing a so-called margin area.

In a series of operations shown from FIG. 21 to FIG. 28, a new title is provided in the management information file in accordance with the change of the recording destination file. Specifically, as shown in FIG. 27 and FIG. 28, the title first loop-recorded into the second AV stream file 45 is PG#0, and the title loop-recorded into the third AV stream file 46 to which the recording destination file is changed is a new PG#p. However, this operation is not restrictive, and for example, after the recording destination file is changed to the third AV stream file 46, without providing a new title, the title PG#0 may include both the reference information and time map information which indicate a portion transferred to the first AV stream file 44 and the reference information and time map information which indicate the AV data stream being loop-recorded into the third AV stream file 46.

As described above, according to the recording apparatus of this embodiment, the management information managing unit 51 manages the management information for normal recording and the management information for loop recording by means of the program group information 42 and AV file information 43 which are common to normal recording and loop recording, and therefore, the management information can be provided to a user as the program information without any distinction between normal recording and loop recording.

Further, according to the recording apparatus of this embodiment, a relatively large area is reserved as the loop recording area, and therefore, even in a case where a save instruction of a currently loop-recorded program is given during the loop recording, the whole program can be recorded. Moreover, according to the recording apparatus of this embodiment, since the loop time for loop recording is extendable according to the time length or the like of a program, a long-hour program can be recorded irrespective of the setting by a user. Further, according to the recording apparatus 10 of this embodiment, since the start point of the loop recording can be dynamically shifted based on the obtained program information about a currently loop-recorded program, it is possible to effectively use the loop recording area by setting an unnecessary recording area free.

### MODIFIED EXAMPLES

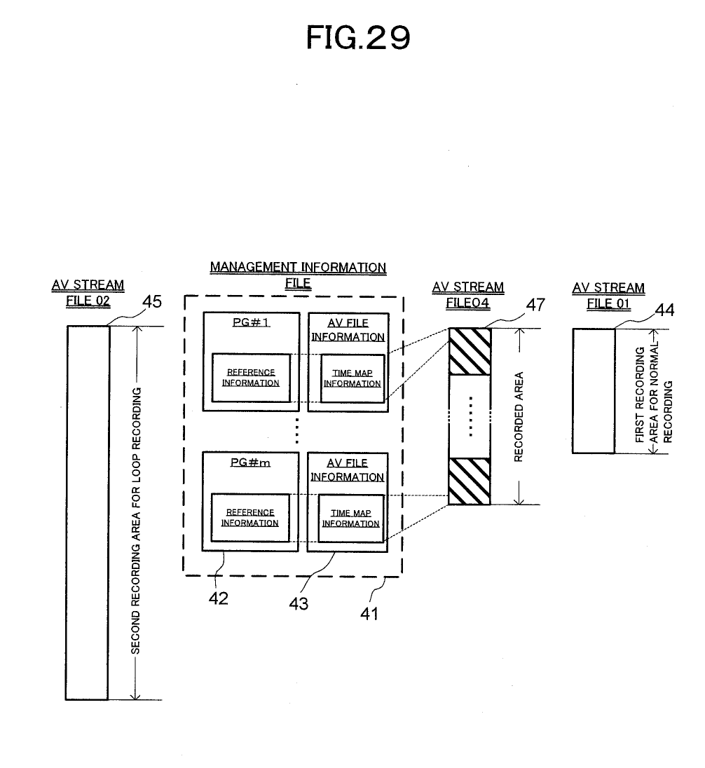

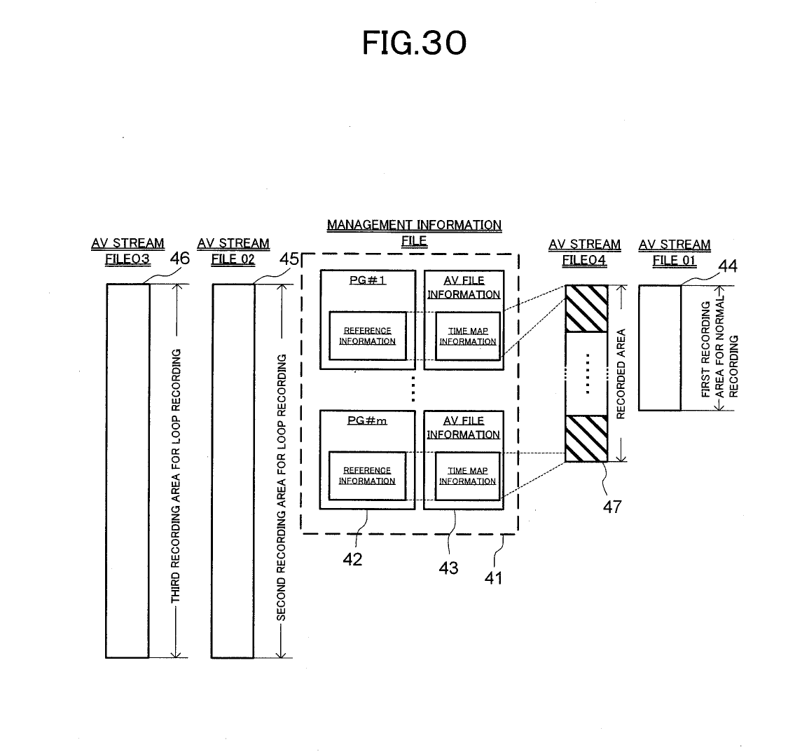

Next, modified examples of the first and second embodiments according to the present invention will be described. FIG. 29 is a schematic chart showing recording areas according to a modified example of the first embodiment of the present invention, and FIG. 30 is a schematic chart showing recording areas according to a modified example of the second embodiment of the present invention.

In the modified example shown in FIG. 29, as the recording areas, at least three AV stream files are provided, among which one and another (a first and a second AV stream file 44 and 45) are assigned to normal recording and loop recording respectively, and the other (fourth AV stream file 47) is assigned as a specialized archive file dedicated to the saving of contents.

In the modified example shown in FIG. 30, as the recording areas, at least four AV stream files are provided, among which one AV stream file (first AV stream file 44) is assigned to normal recording, two AV stream files (second and third AV stream files 45 and 46) are assigned to loop recording, and the other (fourth AV stream file 47) is assigned as a specialized archive file dedicated to the saving of contents.

According to the modified examples shown in FIG. 29 and FIG. 30, the first AV stream file 44 is usable as a specialized recording area of an AV data stream recorded through normal recording, and therefore, if the recording apparatus includes a plurality of encoders and tuners, the execution of normal recording in parallel to the execution of loop recording is possible, for instance. At this time, as can be easily inferred from the contents described in the present invention, it is a matter of course that contents recorded through normal recording can be saved in the fourth AV stream file 47 even before the end of the loop recording, or loop-recorded contents can be saved in the fourth AV stream file 47 even before the end of normal recording.

### OTHER EMBODIMENT

It is to be understood that the present invention is not limited to the above-described specific embodiments, and can be embodied with the elements modified without departing from the spirit and scope of the invention. The present invention can be embodied in various forms by appropriate combinations of the plural elements disclosed in the embodiments described above. For example, some of all the elements shown in the embodiments may be deleted. Further, elements in different embodiments may be combined appropriately. That is, two AV stream files or more for normal recording may be provided, three AV stream files or more for loop recording may be provided, two AV stream files or more for archive may be provided, or these forms may be combined.

Although the above embodiments have been described chiefly based on the hardware configuration, the embodiments may be implemented by software such as a computer program. Software may be stored in a computer-readable storage medium such as a flexible disk, or software (program) may be solely transmitted. In this case, operations of the processing in the respective embodiments can be realized by the computer reading the software (program) stored in the storage medium, or by downloading the software from a LAN or the Internet (server) and installing the downloaded software.

That is, the software (program) of the present invention is not limited to that stored in a storage medium independent of a computer, and includes those distributed via a transmission medium such as a LAN or the Internet.

The storage medium is not limited to a flexible disk, but may be any storage medium, irrespective of its storage form, capable of storing a program and recording data and computer-readable, such as, for example, a magnetic disk, an optical disk (CD-ROM, CD-R, DVD, or the like), a magneto-optical disk (MO or the like), or a semiconductor memory.

In accordance with an instruction from a program installed into a computer from the storage medium, an OS (Operating System) running on the computer, MW (middleware) such as database management software and network software, or the like may perform portions of respective operations of the processing for implementing the present embodiments.

The storage medium is not limited to a medium independent of a computer, and includes a storage medium to which a program transmitted via a LAN or the Internet is downloaded and stored or temporarily stored. The number of the storage mediums is not limited to one. In a case where the processing in the embodiments is executed from a plurality of mediums, these mediums are also included in the recording medium of the present invention. The medium may assume any configuration.

Based on a program stored in the storage medium, the computer executes respective operations of the processing in the present embodiments, and the computer may assume any configuration, such as one apparatus formed by a personal computer or the like, or a system in which a plurality of apparatuses are network-connected.

The computer is not limited to a personal computer and includes an arithmetic processing unit, a microcomputer, and the like included in an information processing apparatus. That is the computer is a generic name representing equipment or apparatuses which can realize the functions of the present invention through a program.

What is claimed is:

1. A recording apparatus comprising:
a first area generating unit generating, in a recording medium, a first recording area used for recording first stream data;
a second area generating unit generating, in the recording medium, a second recording area used for repeatedly overwrite-recording second stream data, the second stream data being different from the first stream data and taken as an object of reproduction only for a predetermined period;
a recording unit recording the second stream data into the second recording area;
a time information obtaining unit obtaining a time length taken to record the second stream data;
a loop time managing unit which compares the time length and the predetermined period in response to a save instruction of the second stream data, and when the time length is longer than the predetermined period, updates a length of the predetermined period to a length equal to or longer than the time length; and
an area transfer unit transferring, to the first recording area, the second stream data having the time length and recorded in the second recording area.

2. The recording apparatus according to claim 1, wherein the recording unit stops the recording of the second stream data when the recording reaches an end point of the time length, and
the area transfer unit transfers, to the first recording area, the recorded second stream data whose recording has reached the end point of the time length.

3. The recording apparatus according to claim 1, wherein the area transfer unit transfers the second stream data recorded in the second recording area to the first recording area so as to match reproduction sequence.

4. The recording apparatus according to claim 1, further comprising a third area generating unit generating, in the storage medium, a third recording area different from the second recording area and used for repeatedly overwrite-recording the second stream data, wherein the recording unit stops the overwrite-recording of the second stream data into the second recording area when the recording of the second stream data reaches an end point of the time length, and records the second stream data into the third recording area instead of the second recording area, and
the area transfer unit transfers, to the first recording area, the second stream data which has been recorded into the second recording area and whose recording has reached the end point of the time length.

5. The recording apparatus according to claim 1, wherein a time length recordable in the second recording area is longer than the predetermined period.

6. The recording apparatus according to claim 1, wherein only the second stream data transferred from the second recording area by the area transfer unit is recorded as the first stream data into the first recording area.

7. A recording/reproducing system, comprising:
a first area generating unit generating, in a recording medium, a first recording area used for recording first stream data;
a second area generating unit generating, in the recording medium, a second recording area used for repeatedly overwrite-recording second stream data, the second stream data being different from the first stream data and taken as an object of reproduction only for a predetermined period;
a recording unit recording the second stream data into the second recording area;
a time information obtaining unit obtaining a time length taken to record the second stream data;
a loop time managing unit which compares the time length and the predetermined period in response to a save instruction of the second stream data, and when the time length is longer than the predetermined period, updates a length of the predetermined period to a length equal to or longer than the time length;
an area transfer unit transferring, to the first recording area, the second stream data having the time length and recorded in the second recording area; and
a display unit displaying at least one of the second stream data recorded in the second recording area and the second stream data transferred to the first recording area.

8. A recording method, comprising:
generating, in a recording medium, a first recording area used for recording first stream data;
generating, in the recording medium, a second recording area used for repeatedly overwrite-recording second stream data, the second stream data being different from the first stream data and taken as an object of reproduction only for a predetermined period;
recording the second stream data into the second recording area;
obtaining a time length taken to record the second stream data;
comparing the time length and the predetermined period in response to a save instruction of the second stream data, and when the time length is longer than the predetermined period, updating a length of the predetermined period to a length equal to or longer than the time length; and
transferring, to the first recording area, the second stream data having the time length and recorded in the second recording area.

9. The recording method according to claim 8, wherein:
the recording of the second stream data is stopped when the recording reaches an end point of the time length; and
in the transferring, the recorded second stream data whose recording has reached the end point of the time length is transferred to the first recording area.

10. The recording method according to claim 8, wherein in the transferring, the second stream data recorded in the second recording area is transferred to the first recording area so as to match reproduction sequence.

11. The recording method according to claim 8, further comprising: generating, in the storage medium, a third recording area different from the second recording area and used for repeatedly overwrite-recording the second stream data, wherein the overwrite-recording of the second stream data into the second recording area is stopped when the recording of the second stream data reaches an end point of the time length, and the second stream data is recorded into the third recording area instead of the second recording area, and
in the transferring, the second stream data which has been recorded into the second recording area and whose recording has reached the end point of the time length is transferred to the first recording area.

12. The recording method according to claim 8, wherein a time length recordable in the second recording area is longer than the predetermined period.

13. The recording method according to claim 8, wherein only the second stream data transferred from the second recording area is recorded as the first stream data into the first recording area.
